(19) United States
(12) Patent Application Publication
(10) Pub. No.: US 2022/0084406 A1
(43) Pub. Date: Mar. 17, 2022

(54) INFORMATION TRANSMISSION DEVICE, INFORMATION COLLECTION DEVICE, INFORMATION TRANSMISSION METHOD, INFORMATION COLLECTION METHOD, AND MOBILE ENTITY

(71) Applicant: Preferred Networks, Inc., Tokyo (JP)

(72) Inventors: Hirochika ASAI, Tokyo (JP); Masahiro ISHIYAMA, Tokyo (JP); Yusuke DOI, Tokyo (JP)

(21) Appl. No.: 17/531,549

(22) Filed: Nov. 19, 2021

Related U.S. Application Data
(63) Continuation of application No. PCT/JP2020/020153, filed on May 21, 2020.

(30) Foreign Application Priority Data
May 21, 2019 (JP) 2019-095253

(51) Int. Cl. G08G 1/0967; G01C 21/00; G08G 1/01; G08G 1/052; G08G 1/04; G07C 5/02; G07C 5/00

(52) U.S. Cl. CPC G08G 1/096791; G01C 21/3841; G08G 1/096733; G08G 1/0112; G07C 5/008; G08G 1/052; G08G 1/04; G07C 5/02; G08G 1/0141

(57) ABSTRACT

According to one embodiment, an information transmission device includes processing circuitry, transmitting circuitry and receiving circuitry. The processing circuitry acquires surrounding information of a mobile entity including the information transmission device. The transmitting circuitry transmits first data including state information of the mobile entity, the first data not including the surrounding information, a data size of the state information is smaller than a data size of the surrounding information. The receiving circuitry receives a transmission control request of the surrounding information after the first data is transmitted, the transmission control request being generated based on the first data. The transmitting circuitry controls transmission of the surrounding information based on the transmission control request.

### CROSS REFERENCE TO RELATED APPLICATIONS

This application is a Continuation of International Application No. PCT/JP2020/020153, filed on May 21, 2020, the entire contents of which is hereby incorporated by reference.

### FIELD

The present disclosure relates to an information transmission device, an information collection device, an information transmission method, an information collection method, and a mobile entity.

### BACKGROUND

Dynamic map data with real-time traffic situation can be generated by collecting surrounding information of mobile entities such as automobiles from sensors in the mobile entities and combining the collected information with the map data. By utilizing such dynamic map data for autonomous driving of vehicles and advanced driver assistance thereof, it is expected to increase recognition performance of autonomous driving, safety of driving, and efficiency of driving.

If each mobile entity uploads surrounding information according to autonomous determination, multiple similar pieces of information are collected for an area in which a great number of mobile entities exist, and thereby use efficiency of communication channels is reduced. Furthermore, due to communication congestion, availability of the communication channels may be reduced and information cannot be uploaded. Even if the information is transmitted with delay for the purpose of avoiding communication congestion, the above problem that multiple similar pieces of information are collected is not still solved. In the meantime, if the surrounding information to be collected is decimated randomly, it may not be possible to collect the surrounding information in a timely manner in an area where the density of the mobile entities is coarse.

### BRIEF DESCRIPTION OF THE DRAWINGS

FIG. 1 is a diagram illustrating an overall configuration of an information collection system according to a first embodiment of the present disclosure;

FIG. 2 is a block diagram of an information transmission device, an information collection device, and a model management device;

FIG. 3 is a chart illustrating an example of data stored in a surrounding information storage in a form of table;

FIGS. 4A and 4B illustrate format examples of metadata;

FIG. 5 is a chart illustrating an example of metadata stored in a metadata storage;

FIG. 6 is a sequence chart of the information collection system according to the first embodiment;

FIGS. 7A and 7B illustrate flowcharts of operation examples of the information transmission device according to the first embodiment;

FIGS. 8A and 8B illustrate flowcharts of operation examples of the information collection device according to the first embodiment;

FIG. 9 is a block diagram of a first modification example of the information collection system according to the first embodiment;

FIG. 10 is a chart illustrating a format example of an upload request according to a second modification example of the first embodiment;

FIG. 11 is a chart illustrating a format example of a data operation request;

FIG. 12 is a chart illustrating an example where columns of save flag and retention period are added to the surrounding information storage;

FIG. 13 is a block diagram illustrating an overall configuration of an information collection system according to a second embodiment;

FIG. 14 illustrates a format example of metadata according to the second embodiment;

FIG. 15 is a flowchart illustrating an example of processing for adding metadata;

FIGS. 16A to 16E illustrate format examples of a transmission control request according to a third embodiment; and

FIG. 17 is a block diagram illustrating an example of a hardware configuration according to an embodiment of the present disclosure.

### DETAILED DESCRIPTION

According to one embodiment, an information transmission device includes processing circuitry, transmitting circuitry and receiving circuitry. The processing circuitry acquires surrounding information of a mobile entity including the information transmission device. The transmitting circuitry transmits first data including state information of the mobile entity, the first data not including the surrounding information, a data size of the state information is smaller than a data size of the surrounding information. The receiving circuitry receives a transmission control request of the surrounding information after the first data is transmitted, the transmission control request being generated based on the first data. The transmitting circuitry controls transmission of the surrounding information based on the transmission control request.

Hereinafter, embodiments of the present disclosure will be described with reference to the accompanying drawings. It is to be noted that the drawings schematically illustrate the embodiments of the present disclosure as a way of example and that the embodiments of the present disclosure are not limited by the forms disclosed in the drawings.

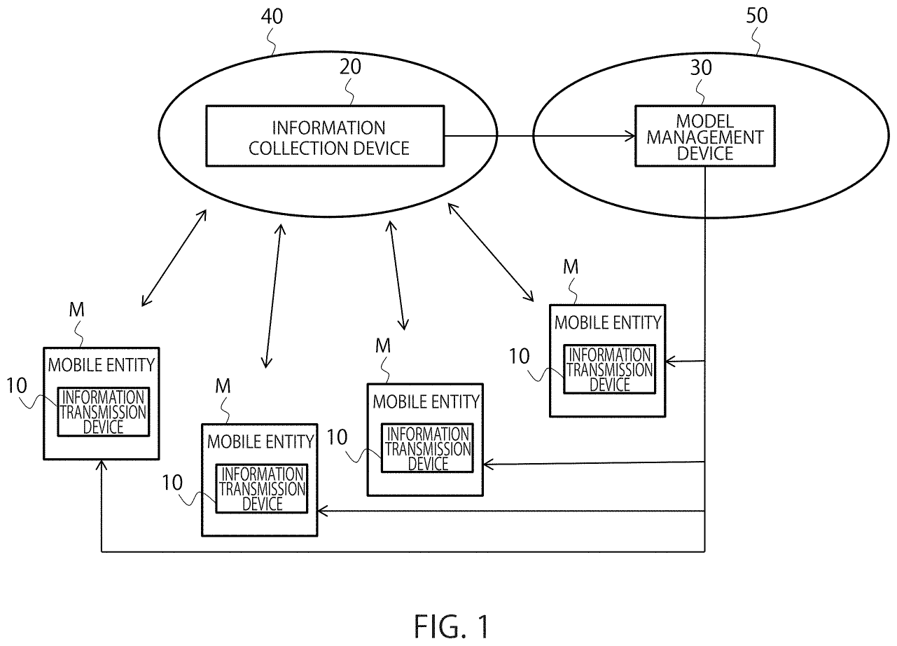

FIG. 1 is a diagram illustrating an overall configuration of an information collection system according to a first embodiment of the present disclosure. The information collection system illustrated in FIG. 1 includes a plurality of mobile entities M each being equipped with an information transmission device 10, an information collection device (server) 20, and a model management device 30.

The mobile entity M is a mobile entity capable of detecting surrounding environmental information (surrounding information) by using a sensor. The sensor is a camera, a LiDAR (Light Detection And Ranging), or both of those, for example. In the embodiment, the mobile entity M is an automobile. Examples of the automobile may be a vehicle having a function of assisting driving of the user and a self-driving car that is capable of autonomous determination and traveling. However, the mobile entity M is not limited to an automobile but may be other types of mobile entity such as a robot, a ship, a drone, or a train. The mobile entity M has an environment model indicating the travel environment of the mobile entity M, and supports the driving of the user or performs autonomous determination by using the environment model. An example of the environment model is dynamic map data acquired by adding real-time traffic environmental situation to three-dimensional map data. “Realtime” herein means that the environment model is updated in a timely manner by the model management device 30.

The information transmission device 10 of the mobile entity M is connected to a communication network 40.

Examples of the communication network 40 include a mobile network, a wireless LAN (Local Area Network), and the like. In the embodiment, it is assumed that the communication network 40 is a mobile network. Examples of the mobile network are 3G network, an LTE network, a next generation (5G) network, and the like, and any type of those networks may be used. The communication network 40 is not limited to be wireless but may also be a wired network.

The information transmission device 10 of the mobile entity M executes a predetermined connection process to connect to a nearby base station among a plurality of base stations disposed in the communication network 40. The information transmission device 10 of the mobile entity M communicates with the information collection device 20 via the connected base station. When the mobile entity M comes close to another base station due to traveling, it is possible to switch the connection destination to another base station by a handover procedure.

The information collection device 20 is a device that collects surrounding information from each of the mobile entities M. The information collection device 20 is disposed in the communication network 40. The communication network 40 in the embodiment is a mobile network, and the information collection device 20 is disposed in the mobile network. In this case, an example of the information collection device 20 is an edge controller of the mobile network.

The information collection device 20 is connected to the base station within the communication network 40 wirelessly or with wire, and it is capable of communicating with each of the mobile entities M via the base station. It is assumed that the information collection device 20 in the embodiment is connected to the base station wirelessly. As an example, the information collection device 20 is disposed on a one-to-one basis with the base station. Note, however, that the information collection device 20 may be disposed by corresponding to two or more base stations. In that case, the information collection device 20 communicates with the information transmission devices 10 of the mobile entities M belonging to each base station via each of the two or more base stations. A plurality of information collection devices 20 may operate in cooperation with each other. Note that communication between the information collection device 20 with each of the mobile entities M is not limited to communication via the base station. Furthermore, the base station itself may have the function of the information collection device 20.

The model management device 30 is a device that manages and updates the environment model. The model management device 30 is disposed in a communication network 50. The communication network 50 is a wide area network such as the Internet (cloud). The model management device 30 communicates with one or a plurality of information collection devices 20 via the communication networks 40 and 50. The model management device 30 acquires the surrounding information of the mobile entities M collected by each of the information collection devices 20, and updates the environment model based on the acquired surrounding information.

Furthermore, the model management device 30 is communicable with the information transmission devices 10 of each of the mobile entities M via the communication network 50. Upon updating the environment model, the model management device 30 provides update data of the environment model to the mobile entity M via the communication network 40 or the communication network 50. The mobile entity M updates the environment model within the mobile entity M with the update data provided from the model management device 30. Thereby, the environment model within the mobile entity M is updated in a timely manner.

In the information collection system described above, there is a scheme in the embodiment for the information collection device 20 to efficiently collect the surrounding information from each of the mobile entities M. When the surrounding information is acquired, the information transmission devices 10 of each of the mobile entities M do not immediately transmit the surrounding information to the information collection device 20 but save it in the internal storages once. Then, the information transmission devices 10 use the sensors to acquire the state information that is the information indicating the state of the mobile entities M when the surrounding information is acquired, and transmit metadata that is the first data including the acquired state information to the information collection device 20. The information collection device 20 selects the mobile entity M caused to transmit the surrounding information based on the metadata received from each of the mobile entities M. The information collection device 20 transmits, to each of the selected mobile entities M, a transmission control request regarding the surrounding information or a transmission control request regarding the metadata.

Examples of the transmission control request may be a transmission request for requesting transmission of surrounding information (upload request), a request for changing transmission rate of surrounding information (transmission rate change request), a request for changing time interval for acquiring surrounding information or time interval for acquiring metadata (transmission interval change request), a request for changing redundancy of surrounding information (redundancy change request), a request for transmitting metadata that satisfies designated condition (metadata control request), and a request for stopping transmission of surrounding information (transmission stop request). The examples of the transmission control request are simply provided as examples, and other kinds of requests may also be transmitted. Hereinafter, mainly described is a case where the transmission control request is a request for transmitting surrounding information (upload request).

When the transmission control request is an upload request of the surrounding information, each of the mobile entities M upon receiving the upload request transmits the surrounding information designated by the upload request. Thereby, the information collection device 20 can efficiently collect the surrounding information effective for updating the environment model. Furthermore, the traffic between the base station and a plurality of mobile entities M can be suppressed, so that it is possible to avoid congestion of the access lines between the base station and the mobile entities M. Hereinafter, such an information collection system according to the embodiment will be described in detail.

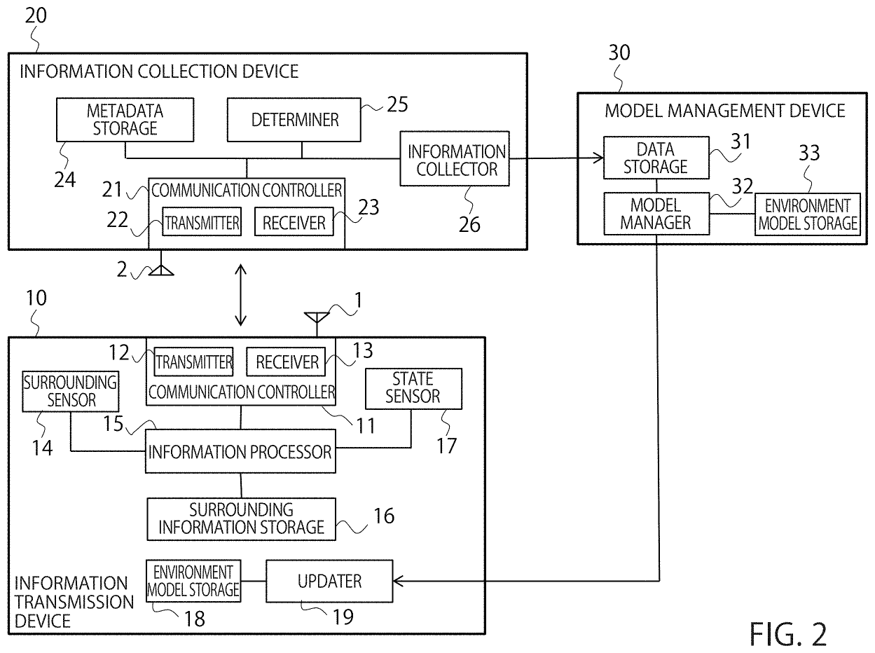

FIG. 2 is a block diagram illustrating configuration examples of the information transmission device 10 of the mobile entity M, the information collection device 20, and the model management device 30. Even though only the information transmission device 10 of a single mobile entity M is illustrated herein, the information transmission devices 10 of other mobile entities also have the same configuration.

The information transmission device 10 of the mobile entity M includes an antenna 1, a communication controller 11, a surrounding sensor 14, an information processor 15, a surrounding information storage 16, a state sensor 17, an environment model storage 18, and an updater 19. The communication controller 11 includes a transmitter 12 and a receiver 13.

The surrounding sensor 14 is a sensor that detects the environmental information in the surrounding (surrounding information) of the mobile entity M. The surrounding sensor 14 detects the surrounding information by every specific time or at an arbitrary timing, for example. The surrounding sensor 14 provides the detected surrounding information to the information processor 15.

The surrounding sensor 14 includes at least one of a camera and a LiDAR (Light Detecting And Ranging), for example. It is possible to acquire image data of the surrounding with the camera. It is possible to acquire 3D point cloud data with the LiDAR. The 3D point cloud data is data that is a set of three-dimensional positions of each of the points. It is also possible to identify the color of each point of the 3D point cloud data by performing matching of the image data. The image data may be a still image or a moving image. As a way of example, the configuration of a still image is expressed by three-dimensional vectors with pixel positions (X, Y) and color (channel) C. As a way of example, the configuration of a moving image is expressed by four-dimensional vectors in which time T is added to the three-dimensional vectors. Note that the surrounding sensor 14 is not limited to the camera or the LiDAR but may be other sensors, and it is also possible to include another sensor in addition to at least one of the camera and the LiDAR. Examples of other sensors include a sensor that detects steering angles, a sensor that detects depression of at least one of an accelerator pedal and a brake pedal, a sensor that detects the fuel injection amount in engine control, or a sensor that detects at least one of engine speed, speed, and gear ratio.

As another example of the timing at which the surrounding sensor 14 detects the surrounding information, there is a timing where a predetermined event occurs in the mobile entity M. Examples of a predetermined event may be events where the user steps on the brake suddenly, where the user turns the steering abruptly, and where the user operates the windshield wipers. Furthermore, there are also events where oscillation of more than a specific level is detected, and the like.

The information processor 15 receives the surrounding information detected by the surrounding sensor 14. The information processor 15 adds a data ID and time information (timestamp) to the acquired surrounding information. The data ID uniquely identifies the surrounding information. The information processor 15 provides the data including the surrounding information having the added information to the surrounding information storage 16. The surrounding information storage 16 stores the provided data to the internal storage area. The same data ID may be used for the surrounding information detected from the same surrounding sensor or the data ID may be changed (may be incremented, for example) every time the surrounding information is detected even when detected by the same surrounding sensor. In a case where the same data ID is used for the surrounding information detected by the same surrounding sensor, the surrounding information can be identified based on a pair of the data ID and the time information (timestamp) (in this case, the data ID corresponds to a sensor ID that identifies the surrounding sensor). In the meantime, in a case where the data ID is changed every time the surrounding information is detected even when detected by the same surrounding sensor, the surrounding information can be identified by the data ID. As another example, the data ID may be changed according to the state of the mobile entity. For example, the data ID may be fixed from the point where the engine of the mobile entity is started to the point where it is turned off, and the data ID may be changed thereafter. In the explanations hereinafter, it is to be assumed that the data ID is changed (incremented) every time the surrounding information is detected unless otherwise noted.

The information processor 15 may add information other than those mentioned above to the surrounding information. For example, weather information (weather, temperature, humidity, and the like) at the time when the surrounding information is acquired may be added. The weather information can be acquired from a car navigation system equipped in the mobile entity M, for example. Note that a configuration of the surrounding information without adding the data ID or the time information is also possible.

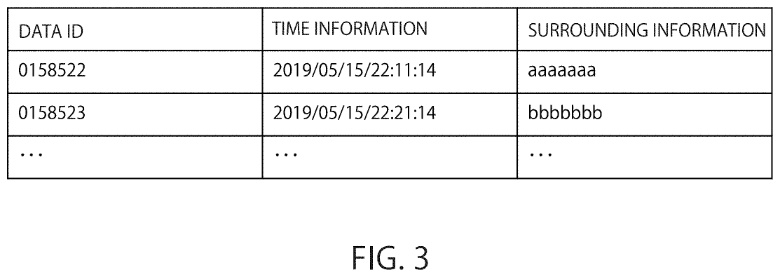

FIG. 3 is a chart illustrating an example of the data stored in the surrounding information storage 16 in a form of table. In this example, a plurality of sets each having a data ID, time information, and surrounding information are stored.

The state sensor 17 detects the information indicating the state of the mobile entity M (state information). As an example, the state information includes positional information of the mobile entity M. The positional information may be the position expressed by two-dimensional or three-dimensional coordinates, or may be the information identifying the place, a section of a road, or the like. The state information may include information other than the positional information. For example, the state information may include information of the direction (orientation) toward which the mobile entity M is facing. Furthermore, the state information may include speed information, acceleration information, or the like of the mobile entity M. The state information may include one of the positional information and the orientation information.

Furthermore, the state information may include one of the positional information, the orientation information, the speed information, and the acceleration information.

In a case of detecting the positional information of the mobile entity M, the state sensor 17 is a receiver of a positioning system, for example. The positioning system may be a satellite positioning system such as a GPS or may be other systems. In a case of detecting the orientation information, the state sensor 17 is an orientation sensor, for example. In a case of detecting the speed information or the acceleration information, the state sensor 17 is a speed sensor or an acceleration sensor, for example. The speed information may be calculated by integrating the acceleration. An appropriate sensor may be used depending on the kind of the information to be detected.

Upon receiving the surrounding information from the surrounding sensor 14, the information processor 15 acquires the state information from the state sensor 17. The information processor 15 gives, to the acquired state information, the ID (node ID) of the mobile entity M and the data ID that is same as the data ID given to the surrounding information to generate first data. Hereinafter, the first data is called metadata. Note, however, that “metadata” is one way of calling it, and the first data may also be called as desired. In addition to the information mentioned above, the metadata can also include other information. Hereinafter, examples of other information included in the metadata are described in (A) to (F).

(A) The time information at the time when the state information or the surrounding information is acquired may be included.

(B) The metadata may include the value of the data size of the surrounding information.

(C) Information of user event occurring in the mobile entity M at the time of acquiring the surrounding information or the state information may be included. Examples of the user event may be cases where the user steps on the brake, where the user turns the steering, and where the user operates the windshield wipers. While the user event is defined separately from the state information herein, the user event may be defined as an element of the state information.

(D) Regarding at least one of the surrounding sensor 14 and the state sensor 17, information on the type, the specifications, or both may be included. As examples of the type of the surrounding sensor 14, there are a camera and a LiDAR. Furthermore, in a case of camera, there is information regarding whether it is a front camera or a rear camera. Furthermore, an example of the specifications of the camera may be resolution. In a case where the surrounding sensor 14 includes the camera, information regarding the number of cameras or the installed positions thereof may be included. There may be a single or a plurality of surrounding sensors 14. When there are a plurality of the surrounding sensors 14, the same information is included for each of those. As examples of the type of the state sensor 17, there may be the sensors such as a position sensor (positioning system), an orientation sensor, and an acceleration sensor.

(E) In a case where a sensor other than the surrounding sensor 14 and the state sensor 17 is provided to the mobile entity M, information on the type of another sensor and data detected by another sensor may be included. As examples of the detected data of another sensor, there may be information on an operation state of ABS, a driving state of the windshield wipers, or the like. As for the detected data of another sensor, the data size is sufficiently smaller compared to that of the surrounding information. Furthermore, a part of the information acquired by the surrounding sensor 14 may be included in the metadata.

(F) The weather information (weather, temperature, humidity, and the like) at the time when the surrounding information is acquired may be added. The weather information can be acquired from the car navigation system equipped in the mobile entity M, for example.

As for the metadata, various modifications other than those examples described above are possible. For example, the metadata can be configured without the data ID.

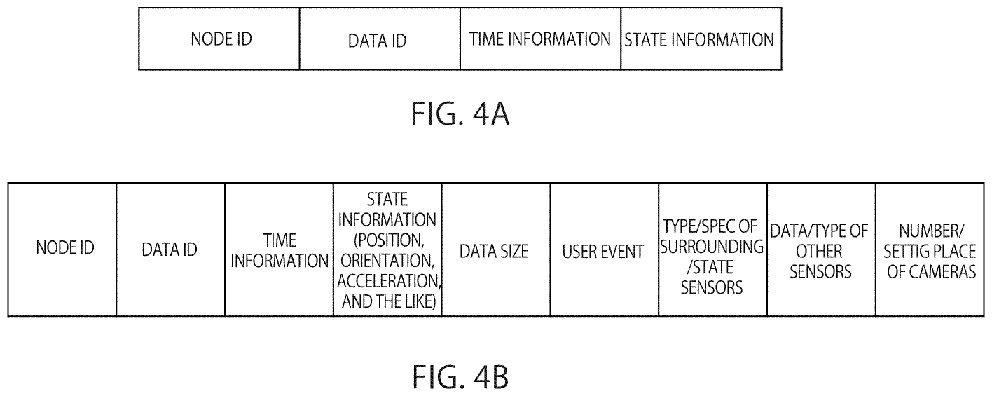

FIG. 4A illustrates a format example of metadata. In this example, a node ID field, a data ID field, a time information field, and a state information field are included. A node ID is set in the node ID field. A data ID is set in the data ID field. The time information at the time when the surrounding information or the state information is acquired is set in the time information field. The state information acquired by the state sensor 17 is set in the state information field.

As a specific example, the node ID is “T2052”, the data ID is “0158523”, the time information is “2019/05/15/22:21:14”, and the state information is “(x coordinate, y coordinate, orientation)=(x2122, y4444, o2445)”. In this example, the data ID is the same as the data ID of the surrounding information on the second row of FIG. 3. The time information is the same as the time information of the surrounding information on the second row of FIG. 3. While the data ID same as that of the surrounding information is given to the metadata in the embodiment, the data ID set for the metadata may not necessarily be consistent with the data ID set for the surrounding information as long as both can be associated. In the explanations hereinafter, it is assumed that the data IDs of both are the same for simplification.

FIG. 4B illustrates another format example of metadata. In this example, in addition to the node ID field, the data ID field, the time information field, and the state information field, a node ID field, a data size field, a user event field, a surrounding/state sensor type/spec field, an another sensor data/type field, a camera number/installed position field are provided. In each of the fields, various kinds of above-described information corresponding to the field names are set. A plurality of items may also be set in a single field. For example, a plurality of sets of sensor type ID and value may be set in “another sensor data/type field”. The sensor type ID indicates the type of the sensor, and the value indicates the data detected by another sensor.

The information processor 15 provides the generated metadata to the communication controller 11.

The communication controller 11 controls the communication with the base station and the information collection device 20 according to the communication protocol used in the communication network 40 and the information collection device 20. The communication controller 11 may additionally have a function of communicating with a communication network (a wireless LAN, for example) different from the communication network 40. The communication controller 11 includes the transmitter 12 and the receiver 13. The transmitter 12 transmits data or information via the antenna 1. The receiver 13 receives data or information via the antenna 1. In a case where the communication controller 11 is compatible with both mobile network and wireless LAN, the transmitter 12 may include a plurality of modems for a mobile network such as 4G and for a wireless LAN. Similarly, the receiver 13 may also include a plurality of modems for a mobile network such as 4G and for a wireless LAN.

The transmitter 12 formats the metadata received from the information processor 15 into a frame format corresponding to the communication protocol to be used. The generated frame is transmitted to the information collection device 20. The frame may be called a packet, a message, or the like. The metadata may be transmitted in a newly defined frame for transmitting the metadata or may be transmitted by being embedded in an existing frame.

As an example, a communication scheme for the base station and a plurality of mobile entities M is time division multiple access, frequency division multiple access, or space division multiple access. However, other communication schemes are also possible. For example, CSMA/CA (Carrier Sense Multiple Access/Collision Avoidance)-base communication scheme may be used as well.

The environment model storage 18 stores an environment model. The environment model is dynamic map data acquired by adding real-time traffic environmental situation and the like to three-dimensional map data. The mobile entity M can conduct autonomous driving, sophisticated driving assistance, and the like of an automobile by using the environment model.

The updater 19 updates the environment model in the environment model storage 18 based on the model update data received from the model management device 30 to be described later.

The information collection device 20 includes an antenna 2, a communication controller 21, a metadata storage 24, a determiner 25, and an information collector 26.

The communication controller 21 controls communication between the base station and the information transmission device 10 of the mobile entity M. The communication controller 21 includes a transmitter 22 and a receiver 23. The transmitter 22 transmits data or information via the antenna 2.

The receiver 23 of the communication controller 21 receives the metadata transmitted from the information transmission device 10. The receiver 23 adds an identifier (node ID) of the mobile entity M to the received metadata. When the node ID is included in the metadata, it is unnecessary to add the node ID. Furthermore, a selection flag of an initial value (=0) is added. The receiver 23 provides the metadata storage 24 with the metadata to which the node ID and the selection flag are added. Furthermore, the receiver 23 notifies the determiner 25 that the metadata is received.

The metadata storage 24 saves the metadata provided from the receiver 23 in a storage area inside thereof.

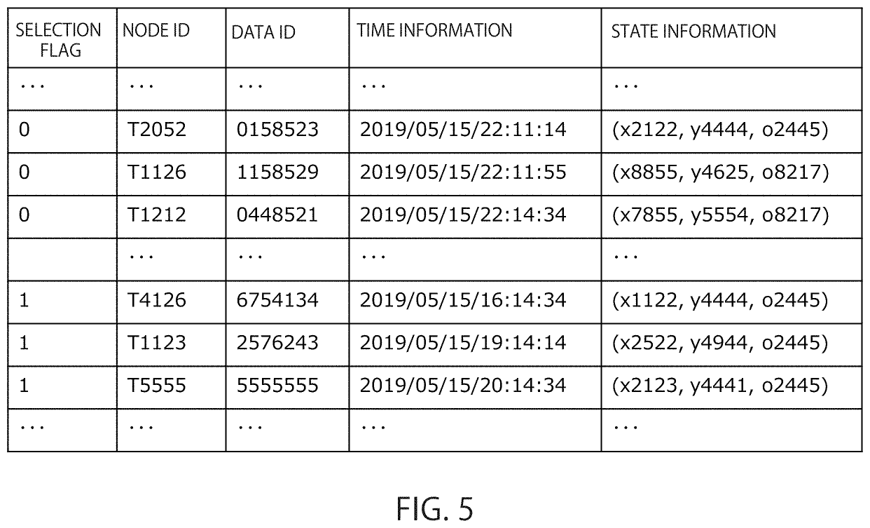

FIG. 5 illustrates an example of the metadata stored in the metadata storage 24. In this example, a plurality of sets each having a selection flag, a node ID, a data ID, time information, and state information (position, orientation) are stored. The metadata with a selection flag of “0” indicates that a surrounding information transmission request (upload request) has not yet been transmitted to the mobile entity M that has transmitted the metadata. The metadata with a selection flag of “1” indicates that a surrounding information transmission request (upload request) has been transmitted to the mobile entity M that has transmitted the metadata. Hereinafter, the metadata with the selection flag of “0” may be called “evaluation target metadata”, and the metadata with the selection flag of “1” may be called “past metadata”. The determiner 25 performs processing (mobile entity selection processing) for selecting the mobile entity M caused to transmit the surrounding information (the mobile entity to be the target of transmission control) from the mobile entities M that have transmitted pieces of evaluation target metadata based on the pieces of metadata (pieces of evaluation target metadata, pieces of past metadata) stored in the metadata storage 24. Note that “to transmit the surrounding information to the information collection device 20 from the mobile entity M” may also be referred to as “to upload the surrounding information”.

The determiner 25 determines whether a start condition of the mobile entity selection processing is satisfied, and performs the mobile entity selection processing when determined as satisfied. As for the start condition, there may be such a condition that a specific time has passed from the previous mobile entity selection processing, for example. Furthermore, there may be such a condition that a specific amount of evaluation target metadata is accumulated anew in the metadata storage 24. Furthermore, there may be such a condition that start indication data of the mobile entity selection processing is received from an external device. The external device may be the model management device 30 or may be other devices. Start conditions other than those discussed herein may be defined as well.

The surrounding information is image or point cloud information acquired by the camera, the LiDAR, or the like, and the data size thereof is larger than that of the metadata. Therefore, if all of the mobile entities M that have transmitted the metadata are to transmit the surrounding information, communication congestion may occur between the base station and the mobile entities M. Furthermore, if a vast amount of surrounding information of the same position or the nearby positions is collected (for example, all of the mobile entities on a road crowded with vehicles as in an urban area are to transmit the surrounding information), the use efficiency of the communication channel is deteriorated. Therefore, in the embodiment, the mobile entities to upload the surrounding information are narrowed down by the mobile entity selection processing. Hereinafter, the mobile entity selection processing will be described in detail.

First, the determiner 25 calculates similarity (E) of each evaluation target metadata (metadata with selection flag of “0”) with respect to each piece of the past metadata (metadata with selection flag of “1”). An example of a similarity calculation formula based on spatial distance and time distance between two pieces of metadata is presented below.

E=1/(α(nₜ−mₜ)²+β(nₓ−mₓ)²+γ(n_{y}−m_{y})²+1) (1)

Note that “n_{y}” and “n_{y}” are positional information (x coordinate and y coordinate) of the past metadata, and “nₜ” is the time information of the past metadata.

Note that “mₓ” and “m_{y}” are positional information (x coordinate and y coordinate) of the evaluation target metadata, and “mₜ” is the time information of the evaluation target metadata.

Note that “α”, “β”, and “γ” are positive weight coefficients given in advance.

Furthermore, orientation information may also be added. An example of a similarity calculation formula in such a case is presented below.

E=1/(α(nₜ−mₜ)²+β(nₓ−mₓ)²+γ(n_{y}−m_{y})²+δ(nₒ−mₒ)²+1) (2)

Note that “nₒ” is the orientation information of the past metadata, “mₒ” is the orientation information of the evaluation target metadata, and “δ” is a positive weight coefficient given in advance.

While the formula (1) and the formula (2) indicate cases of two-dimensional positional information, the positional information may also be three dimensional. In that case, z coordinate may be added.

As can be seen from the formula (1), the larger the difference “(nₜ−mₜ)²” of the time information is, the smaller the value of the similarity E becomes. Furthermore, the larger the difference of the positional information is (that is, the larger the difference “(nₓ−mₓ)” of the x coordinates is, or the larger the difference “(n_{y}−m_{y})” of the y coordinates is), the smaller the value of the similarity E becomes. In the formula (2), the larger the difference “(nₒ−mₒ)²” of the orientations is, the smaller the value of the similarity E becomes.

The formula (1) and the formula (2) are examples of similarity calculation, and various modifications thereof are possible. For example, the terms related to the difference of the time information may be eliminated from the formula (1) and the formula (2). Furthermore, terms regarding the difference of the speed information, the difference of the acceleration information, or the like may be added to the formula (1) and the formula (2).

For each piece of the evaluation target metadata, the similarity E with respect to each piece of the past metadata is calculated, and the smallest similarity E is selected for each piece of the evaluation target metadata. The selected similarity E is referred to as comparison target similarity (referred to as similarity S hereinafter). Then, the similarities S selected for each piece of the evaluation target metadata are compared, and the metadata with the smallest similarity S is preferentially selected. Then, the mobile entity that has transmitted the selected metadata is selected as the mobile entity caused to upload the surrounding information.

As described, by preferentially selecting the mobile entity with the small similarity S, it is possible to select the metadata having a far distance (Euclidean distance) with respect to the positional information and the time information of the past metadata. It is also possible to select the metadata having a far distance (Euclidean distance) with respect to the orientation information of the past metadata. This makes it possible to collect the surrounding information by increasing the use efficiency of the communication channel.

The number of pieces of metadata to be selected (the number of mobile entities to be selected) is defined according to a predefined criterion. As an example of the predefined criterion, a predetermined number of pieces of metadata may be selected. Furthermore, all pieces of metadata whose similarity S is less than a threshold value may be selected. Moreover, the number of pieces of metadata corresponding to a surplus communication capacity that can be used between the base station and the mobile entities M may be selected.

A range of the past metadata as the target for calculating the similarity E with respect to the evaluation target metadata is determined by a method defined in advance. For example, the past metadata within a specific time range going back from the time information of the evaluation target metadata (that is, the difference with respect to the time information of the evaluation target metadata is within a specific time) may be selected. Alternatively, the past metadata whose difference with respect to the execution time of the mobile entity selection processing is within a specific time may be selected.

While the evaluation target metadata is selected based on the similarity between the evaluation target metadata and the past metadata in the example described above, the evaluation target metadata may be selected based on the distance (at least either the spatial distance or the time distance, or the like) between the evaluation target metadata and the past metadata. As described, the evaluation target metadata may be selected based on the similarity and the distance.

In a case where the capacity of the metadata storage 24 is fully occupied or the like, the old metadata in the metadata storage 24 may be deleted or overwritten. For example, the metadata with the time information of more than a predetermined time ago from the current time (metadata with selection flag of “0”, metadata with “1”, or both) may be deleted. Furthermore, unnecessary data may be deleted from the metadata storage 24 by other methods.

The determiner 25 generates an upload request (surrounding information transmission request) for requesting upload of the surrounding information for the mobile entity M selected by the mobile entity selection processing (the mobile entity to be the target of transmission control). As an example, the upload request includes information for specifying the surrounding information to be uploaded by the selected mobile entity M. The determiner 25 specifies the surrounding information to be uploaded by the mobile entity M based on the data ID or the time information included in the evaluation target metadata used for selecting the mobile entity M, for example.

For example, the surrounding information having the data ID same as the above-described data ID is specified as the surrounding information to be uploaded. In this case, the data ID is included in the upload request. Alternatively, the surrounding information within a predetermined time range with respect to the time information is specified as the surrounding information to be uploaded. The predetermined time range is a time range in the past, in the future, or both with respect to the time information. In this case, information for specifying the time range of the surrounding information to be uploaded is included in the upload request.

The determiner 25 provides the generated upload request to the communication controller 21. The transmitter 22 of the communication controller 21 transmits the upload request to the information transmission device 10 of the mobile entity M as the target for generating the upload request. Specifically, the transmitter 22 formats the upload request in a frame format corresponding to the communication protocol to be used. The transmitter 22 transmits the generated frame to the information transmission device 10 of the mobile entity M via the base station.

The determiner 25 may schedule the order of the mobile entities M to transmit the upload request. In this case, the determiner 25 determines the order of upload based on the similarities S of each of the selected mobile entities M. For example, it is determined to transmit the upload request in an ascending order of the similarities S. A transmission schedule defined to transmit the upload request in the determined order is generated. According to the generated transmission schedule, the upload request is transmitted to each of the mobile entities M.

Upon receiving the upload request from the information collection device 20, the receiver 13 of the mobile entity M gives the upload request to the information processor 15. According to the upload request, the information processor 15 specifies the surrounding information to be uploaded in the surrounding information storage 16. The information processor 15 provides the specified surrounding information to the transmitter 12. The transmitter 12 controls transmission of the surrounding information according to the transmission control request. The transmitter 12 herein transmits the surrounding information according to the upload request. The transmitter 12 controls transmission of the surrounding information according to the transmission control request. In this example, the transmitter 12 transmits the provided surrounding information to the information collection device 20 in response to the upload request. Specifically, the transmitter 12 formats the provided surrounding information in a frame format corresponding to the communication protocol to be used. The transmitter 12 transmits the generated frame to the information collection device 20 via the base station. As described, the transmitter 12 transmits the surrounding information based on the upload request (one mode of controlling transmission of the surrounding information according to the transmission control request). Such a mode that the surrounding information is transmitted not to the information collection device 20 but to another device is also possible. For example, the surrounding information may be transmitted to a server in a cloud. The server may be the model management device 30. The server may be defined in advance or may be designated by the information collection device 20 as described in a second modification example to be described later.

Upon receiving the surrounding information from the information transmission device 10 of the mobile entity M, the receiver 23 of the information collection device 20 provides the received surrounding information to the information collector 26. The information collector 26 includes inside thereof a buffer (storage) for temporarily holding the provided surrounding information, and temporarily stores the provided surrounding information to the buffer. Thereby, the information collector 26 collects the surrounding information.

The information collector 26 transmits the collected surrounding information to the model management device 30. When transmission of the surrounding information to the model management device 30 is completed, the surrounding information is deleted from the buffer. Instead of providing the buffer in the information collector 26, a storage accessible from the information collector 26 may be provided outside the information collector 26 to temporarily store the surrounding information to that storage.

The information collector 26 may immediately transmit the surrounding information every time the surrounding information of the information transmission device 10 is received from the receiver 23. Alternatively, the surrounding information may be collectively transmitted by every predetermined time or every predetermined data amount. Furthermore, the surrounding information may be transmitted in response to a request received from the model management device 30. The information collector 26 may determine the timing to transmit the surrounding information in accordance with the load status of the model management device 30. This will be explained in a first modification example to be described later.

The model management device 30 includes a data storage 31, a model manager 32, and an environment model storage 33. The model management device 30 receives the surrounding information transmitted from the information collection device 20, and provides the received surrounding information to the data storage 31. The data storage 31 stores the provided surrounding information inside thereof.

The model manager 32 has the environment model stored therein. As described above, the environment model is dynamic map data acquired by adding real-time traffic environmental situation and the like to three-dimensional map data.

The model manager 32 sequentially reads out the surrounding information that has not been read out from the data storage 31, and updates the environment model stored in the environment model storage 33 based on the read-out surrounding information. After updating the environment model, the model manager 32 may give the update time to the surrounding information used for the update. Alternatively, the surrounding information used for the update may be deleted from the data storage 31. The model manager 32 may set the latest update time of the environment model by associating with the updated environment model.

The model manager 32 transmits the data for updating the environment model to each of the mobile entities M. The data for update may be difference data of before and after the update or may be the updated environment model. Furthermore, update data for an area within a specific distance range from the positions of each of the mobile entities M may be transmitted to the respective mobile entities M. In that case, the model manager 32 acquires the positional information from each of the mobile entities M by having communication.

The condition for transmitting the update data to each of the mobile entities M can be defined arbitrarily. For example, the update data may be transmitted regularly to each of the mobile entities M. Alternatively, the update data may be transmitted upon receiving an update data transmission request from each of the mobile entities M. Furthermore, when an occurrence of a specific event (for example, rockfall, traffic accident, or earthquake) is detected in a certain area, the update data may be immediately transmitted to the mobile entities M existing in the area where the event has occurred or in the vicinity thereof. At that time, the model manager 32 may communicate with a management device (mobile entity management device) that manages the positions of each of the mobile entities M to acquire the identification information (node ID or the like) of the mobile entities M existing in the corresponding area or in the vicinity thereof from the mobile entity management device.

The updater 19 of each of the mobile entities M receives the data for updating the model from the model management device 30 via the communication network 40 or the communication network 50. The updater 19 updates the environment model in the environment model storage 18 according to the received data.

While the model update data herein is directly transmitted to each of the mobile entities M from the model management device 30, it is also possible to transmit such data via another device. For example, the model management device 30 may transmit the model update data to the information collection device 20, and the information collection device 20 may transmit the update data to each of the mobile entities M. In that case, the communication controller 21 of the information collection device 20 transmits the model update data to each of the mobile entities M while controlling the communication regarding the metadata and the upload request.

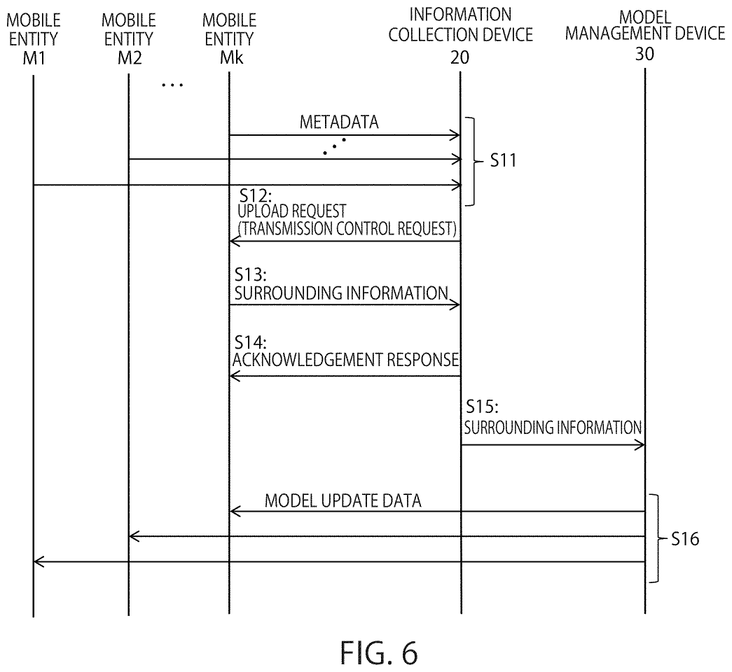

FIG. 6 is a sequence chart of the information collection system according to the embodiment. More specifically, FIG. 6 illustrates an operation sequence of the information transmission devices 10 of a plurality of mobile entities M (M1, M2, . . . , Mk), the information collection device 20, and the model management device 30.

When the surrounding information is detected by using the surrounding sensor 14, each of the mobile entities M1, M2, . . . , Mk stores the detected surrounding information to the surrounding information storage 16. Upon detecting the surrounding information, the mobile entities M1, M2, . . . , Mk acquire the state information of the mobile entities M1, M2, . . . , Mk by using the state sensors and generate the metadata including the acquired state information. As an example, the metadata includes the node ID and the data ID and the time information of the surrounding information. The mobile entities M1, M2, . . . , Mk transmit the generated metadata to the information collection device 20 (S11).

The information collection device 20 performs the mobile entity selection processing described above based on the metadata received from the mobile entities M1, M2, . . . , Mk to select the mobile entity caused to upload the surrounding information. The information collection device 20 transmits, to the selected mobile entity, an upload request (transmission control request) that designates the surrounding information to be uploaded (S12). In the example of FIG. 6, the mobile entity Mk and other mobile entities that are not illustrated are selected, but the mobile entities M1, M2 are not selected. Therefore, the upload request is transmitted to the mobile entity Mk and the other mobile entities (referred to as the mobile entity Mk and the like hereinafter), and no upload request is transmitted to the mobile entities M1, M2.

The mobile entity Mk and the like upon receiving the upload request from the information collection device 20 read out the surrounding information designated in the upload request from the surrounding information storage 16, and transmit the read-out surrounding information to the information collection device 20 (S13). When the upload request is received, the mobile entity Mk and the like may transmit an acknowledgement response indicating that the request has been received. Furthermore, when transmission of the surrounding information is completed, a completion response may be transmitted as well. Upon receiving the surrounding information from the mobile entity Mk and the like, the information collection device transmits an acknowledgement response to the mobile entity Mk and the like (S14). Note that it is also possible to omit transmission of the acknowledgement response.

The information collection device 20 transmits the surrounding information acquired from the mobile entity Mk and the like to the model management device 30 (S15).

The model management device 30 updates the environment model in the environment model storage 33 based on the surrounding information received from the information collection device 20. The model management device 30 transmits the model update data to the mobile entities M1 to Mk based on the updated environment model (S16). The mobile entities M1 to Mk updates the environment model of the mobile entities M1 to Mk in the environment model storage 18 based on the data received from the model management device 30.

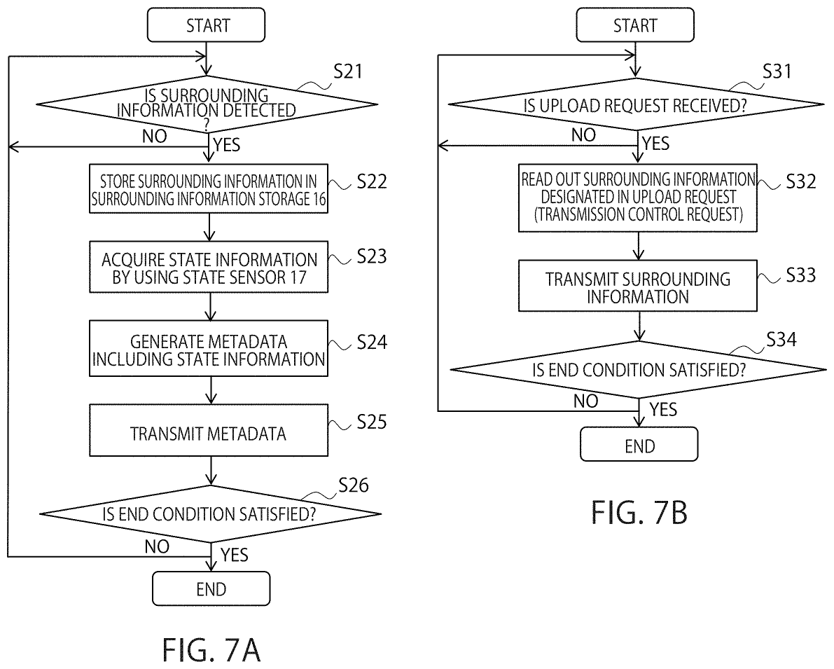

FIG. 7A is a flowchart illustrating an example of a first operation of the information transmission device 10 of the mobile entity M according to the embodiment. When the surrounding sensor 14 detects surrounding information (YES in S21), the information processor 15 acquires the surrounding information from the surrounding sensor 14 and stores it to the surrounding information storage 16 (S22), and acquires the state information of the mobile entity M by using the state sensor 17 (S23). When the surrounding information is not detected (NO in S21), the processing is returned to step S21. The information processor 15 generates the metadata including the acquired state information and the like (S24), and transmits the generated metadata to the information collection device 20 via the transmitter 12 (S25). When a predetermined end condition is satisfied (YES in S26), the processing is ended. When the predetermined end condition is not satisfied (NO in S26), the processing is returned to step S21. Examples of the predetermined end condition may be cases where the user stops the engine of the mobile entity, where the user stops the driving assistance (navigation) system, and the like. Note that acquisition of the state information in step S23 may be constantly executed independently of the acquisition state of the surrounding information. In that case, the state information corresponding to the time same as the time at which the surrounding information is detected from the constantly acquired surrounding information or corresponding to the time closest thereto is specified as the state information to be included in the metadata.

FIG. 7B is a flowchart illustrating an example of a second operation of the information transmission device 10 of the mobile entity M according to the embodiment. When the upload request (transmission control request) is received from the information collection device 20 via the receiver 13 (YES in S31), the information processor 15 reads out the surrounding information designated in the upload request from the surrounding information storage 16 (S32), and transmits the read-out surrounding information to the information collection device 20 via the transmitter 12 (S33). When the upload request is not received (NO in S31), the processing is returned to step S31. When a predetermined end condition is satisfied (YES in S34), the processing is ended. When the predetermined end condition is not satisfied (NO in S34), the processing is returned to step S31. Examples of the predetermined end condition may be cases where the user stops the engine of the mobile entity, where the user stops the driving assistance (navigation) system, and the like.

The operation of FIG. 7A and the operation of FIG. 7B may be executed in parallel or may be executed in order.

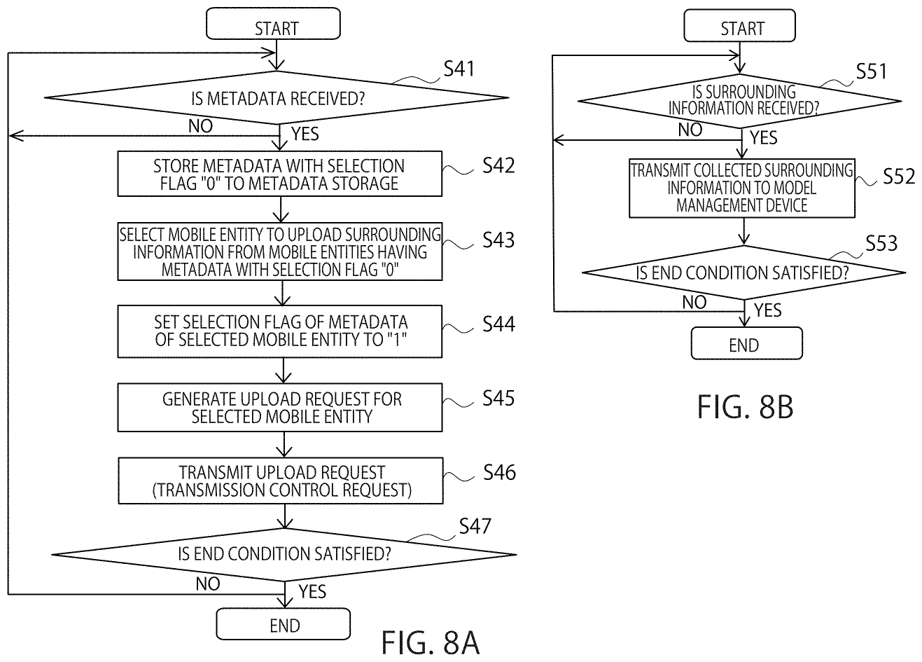

FIG. 8A is a flowchart illustrating an example of a first operation of the information collection device 20 according to the embodiment. When the metadata is received from the mobile entity M via the receiver 23 (YES in S41), the determiner 25 stores the metadata whose selection flag is set as “0” to the metadata storage 24 (S42). When the metadata is not received (NO in S41), the processing is returned to step S41. The determiner 25 performs the mobile entity selection processing to select the mobile entity caused to upload the surrounding information from the mobile entities of the metadata (evaluation target metadata) with the selection flag of “0” (543). The determiner 25 sets the selection flag of the metadata of the mobile entity selected by the mobile entity selection processing to “1” (“selected”) (S44). The determiner 25 generates the upload request (transmission control request) designating the surrounding information to be uploaded by the selected mobile entity (S45), and transmits the generated upload request to the selected mobile entity via the transmitter 22 (S46). When a predetermined end condition is satisfied (YES in S47), the processing is ended. When the predetermined end condition is not satisfied (NO in S47), the processing is returned to step S41. Examples of the predetermined end condition may be cases where the administrator turns off the power of the information collection device 20, where there is an error occurred in the information collection device 20 and the power is automatically turned off, and the like.

FIG. 8B is a flowchart illustrating an example of a second operation of the information collection device 20 according to the embodiment. When the surrounding information is received from the mobile entity (YES in S51), the receiver 23 provides the received surrounding information to the information collector 26. The information collector 26 transmits the provided surrounding information to the model management device 30 (S52). When the surrounding information is not received in the receiver 23 (NO in S51), the processing is returned to step S51. When a predetermined end condition is satisfied (YES in S53), the processing is ended. When the predetermined end condition is not satisfied (NO in S53), the processing is returned to step S51. Examples of the predetermined end condition may be cases where the administrator turns off the power of the information collection device 20, where there is an error occurred in the information collection device 20 and the power is automatically turned off, and the like. The surrounding information received in step S51 may be temporarily buffered, and the buffered surrounding information may be collectively transmitted to the information collector 26 when reaching a transmission timing defined in advance.

The operation of FIG. 8A and the operation of FIG. 8B may be executed in parallel or may be executed in order.

As described above, according to the embodiment, each of the mobile entities M transmits the metadata of the small data size to the information collection device 20, and the information collection device 20 has the mobile entities selected according to the metadata upload the surrounding information. This makes it possible to perform collection of the surrounding information by achieving high use efficiency of the communication capacity. Furthermore, since the total traffic of the data transmitted from each of the mobile entities can be suppressed, it is possible to prevent communication congestion.

While the information collection device 20 receives the metadata from each of the mobile entities M in the embodiment, it is also possible to select the mobile entity M caused to transmit the metadata so as to have only the selected mobile entity M transmit the metadata. For example, in a case of collecting images used for a map, the use efficiency of the communication channel is deteriorated if the surrounding information or metadata is transmitted from all of the mobile entities on a road crowded with vehicles as in an urban area. Therefore, the determiner 25 of the information collection device 20 may decimate the mobile entities caused to transmit the metadata. The information collection device 20 transmits the metadata transmission request for requesting transmission of metadata only to the mobile entity desired to transmit the metadata, and the mobile entity transmits the metadata only when designated by the metadata transmission request.

### First Modification Example

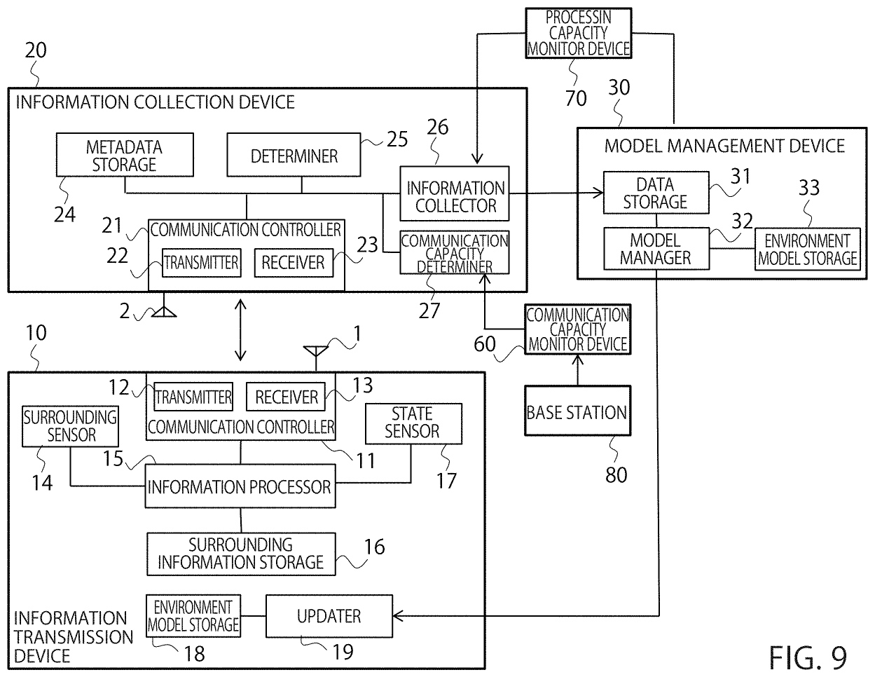

FIG. 9 is a block diagram of a first modification example of the information collection system according to the first embodiment. A communication capacity determiner 27, a communication capacity monitor device 60, and a processing capacity monitor device 70 are added to the information collection system of FIG. 2. The communication capacity determiner 27 is included in the information collection device 20. The communication capacity monitor device 60 is connected to a base station 80 with wire or wirelessly.

Each of the mobile entities M performs communication with the information collection device 20 and various kinds of communication with other systems or devices via the base station 80. The communication capacity monitor device 60 acquires information on surplus communication capacity that can be used between the base station 80 and the mobile entity M from the base station 80, and transmits the acquired information on the surplus communication capacity to the communication capacity determiner 27.

Based on the information received from the communication capacity monitor device 60, the communication capacity determiner 27 grasps the surplus communication capacity that can be used between the base station 80 and the mobile entity M (for example, rate that can be used per unit time). The communication capacity determiner 27 determines the number of mobile entities M (the number of pieces of evaluation target metadata to be selected) to be selected by the determiner 25 based on the grasped surplus communication capacity. For example, the average size of the surrounding information is grasped in advance, and the number of mobiles bodies M to be selected is determined based on the average size and the surplus communication capacity that can be used. Alternatively, when the information regarding the data size of the surrounding information is included in the metadata, the information may be used to determine the number of mobile entities M to be selected (the number of pieces of evaluation target metadata to be selected). The number of mobile entities M to be selected may be determined by other methods. Note that the same mobile entity M may be selected multiple times. In that case, the number of duplicated times may be counted as the number of mobile entities. The communication capacity determiner 27 notifies the information on the determined number to the determiner 25. The determiner 25 selects the notified number of mobile entities M.

While the communication capacity monitor device 60 is described as a separate device from the information collection device 20 and the base station 80 in this example, the communication capacity monitor device 60 may also be equipped in the base station 80 or the information collection device 20.

The processing capacity monitor device 70 acquires information indicating the load status of the model management device 30, such as the CPU utilization of the model management device 30, the free space of the data storage 31, or the like. The processing capacity monitor device 70 transmits the acquired information to the information collector 26 of the information collection device 20. The information collector 26 controls the timing for transmitting the buffered surrounding information based on the acquired information.

For example, the surrounding information is transmitted when the CPU utilization is less than a specific value, and transmission thereof is waited when it is equal to or more than the specific value. Furthermore, the surrounding information is transmitted when the free space of the data storage 31 is less than a specific value, and transmission thereof is waited when it is equal to or more than the specific value. When the free space is less than the specific value, the free space can be increased by expanding the data storage area of the model management device 30, for example. The information collector 26 may discard the surrounding information that cannot be transmitted even after waited for the specific time or more.

While the processing capacity monitor device 70 is described as a separate device from the information collection device 20 and the model management device 30 in the first modification example, the processing capacity monitor device 70 may also be equipped in the information collection device 20 or the model management device 30.

As described above, according to the first modification example, it is possible to prevent an occurrence of communication congestion by determining the number of mobile entities caused to transmit the surrounding information based on the surplus communication capacity that can be used between the base station 80 and each of the mobile entities M. Furthermore, by transmitting the surrounding information in accordance with the load status of the model management device 30, it is possible to securely transmit the surrounding information to the model management device 30 and reflect the surrounding information upon the environment model.

### Second Modification Example

In the first embodiment or the first modification example described above, it is assumed that the information transmission device 10 of the mobile entity M upon receiving an upload request from the information collection device 20 immediately uploads the surrounding information. In the second modification example, an upload condition (transmission condition) is set in the upload request as one form of the transmission control request. The information transmission device 10 uploads the surrounding information according to the upload condition. Hereinafter, specific examples of the upload condition will be described.

As a first example of the upload condition, upload time is designated. For example, when determined that the communication capacity between the base station and the mobile entity M is tight, the determiner 25 of the information collection device 20 designates future time. As an example, future time is time in a time zone where the communication capacity is expected to be not tight. The information processor 15 of the mobile entity M performs control to upload the surrounding information at the time designated in the upload condition. The upload request including the upload time is an example of the transmission control request according to the embodiment.

As a second example of the upload condition, the place for upload is designated. For example, the determiner 25 of the information collection device 20 designates the home of the user of the mobile entity M. In this case, the information processor 15 detects that the user of the mobile entity M has arrived home, and uploads the surrounding information. Whether the user has arrived home may be determined by associating with the navigation system equipped in the mobile entity M, for example. The communication network used for upload may be a mobile network (communication network 40) or may be a wireless LAN. Thereby, the surrounding information can be uploaded by avoiding the congested network. The upload request including the place for upload is an example of the transmission control request according to the embodiment.

As a third example of the upload condition, the type of communication network used for upload is designated. For example, the determiner 25 designates the wireless LAN as the type of communication network. In this case, the information processor 15 of the mobile entity M uploads the surrounding information when connected to the wireless LAN. Thereby, the communication capacity of the mobile network can be prevented from becoming tight. The upload request including the type of the communication network for upload is an example of the transmission control request according to the embodiment.

As a fourth example of the upload condition, the device as the upload destination (transmission destination device) is designated. While the surrounding information is transmitted to the information collection device 20 on the mobile network (communication network 40) in the first embodiment and the first modification example, another device separate from that can be designated as the upload destination. For example, the determiner 25 of the information collection device 20 designates a server on the cloud as the upload destination. The server may be the model management device 30 or a server prepared separately from that. The information processor 15 of the mobile entity M transmits the surrounding information to the server designated in the upload condition. The communication network used for upload may be a mobile network (communication network 40) or may be a wireless LAN. In the latter case, the communication capacity of the mobile network can be prevented from becoming tight. The upload request including the information designating the device as the upload destination (transmission destination device) is an example of the transmission control request according to the embodiment.

As a fifth example of the upload condition, immediate transmission or delayed transmission is designated. “Immediate transmission” means that the mobile entity M upon receiving the upload request transmits the surrounding information immediately after the communication quality capable of achieving transmission is satisfied in the currently connected mobile network or in a mobile network after a handover. The communication quality means that the radio wave quality (SN ratio: Signal to Noise Ratio), transmissible rate, or the like is equal to or more than a specific value, for example. By designating immediate transmission for the surrounding information that is required to be collected quickly in this manner, the surrounding information can be acquired as quick as possible. In the meantime, “delayed transmission” means to transmit the surrounding information when the mobile entity M becomes connected to a LAN such as a wireless LAN. By designating delayed transmission for the surrounding information that is not required to be collected quickly, the communication capacity of the mobile network can be prevented from becoming tight. The upload request including the information designating whether to use immediate transmission or delayed transmission is an example of the transmission control request according to the embodiment.

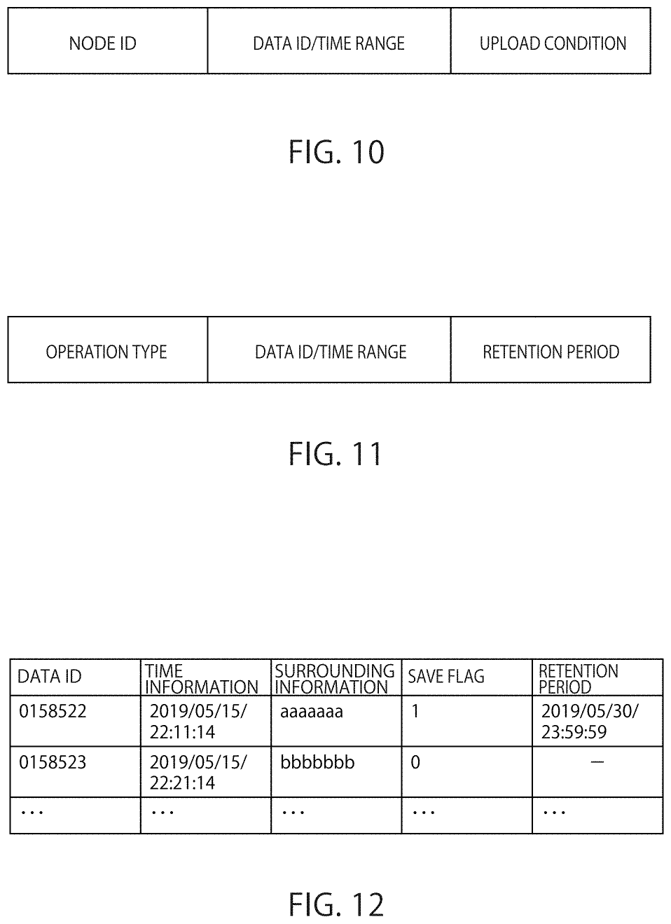

FIG. 10 is a chart illustrating a format example of the upload request according to the second modification example. The upload request includes a node ID field, a data ID/time range field, and an upload condition field. In the node ID field, the node ID of the mobile entity M as the transmission destination of the upload request is designated. In the data ID/time range field, the data ID of the surrounding information as the target or values indicating the time range are set. In a case where the data ID is the same for each surrounding sensor 14, a set of the data ID and the time information or a set of the data ID and the time range is set to designate the surrounding information. In the upload condition field designating the surrounding information to be the target of upload, the above-described upload conditions are designated. A plurality of upload conditions may be combined for designation.

### Third Modification Example

In the first embodiment, the first modification example, or the second modification example, the information collection device 20 upon receiving the metadata from the mobile entity M may transmit, to the mobile entity M, a data operation request designating how to save the surrounding information. The data operation request may be included in the upload request as a part thereof.

FIG. 11 is a chart illustrating a format example of the data operation request. The data operation request in FIG. 11 includes an operation type field, a data ID/time range field, and a retention period field. In the operation type field, a value indicating “save” or “not save” is set as an operation type. In the data ID/time range field, the data ID of the surrounding information as the target or values indicating the time range are set. In a case where the data ID is the same for each surrounding sensor 14, a set of the data ID and the time information or a set of the data ID and the time range is set to designate the surrounding information. In the retention period field, values indicating the retention period of the surrounding information to be the target are set.

When the operation type is “not save”, it means that the surrounding information can be preferentially deleted. When the memory capacity in the surrounding information storage 16 becomes insufficient in the mobile entity M, unnecessary surrounding information is deleted. At this time, the surrounding information whose operation type is set as “not save” is preferentially deleted in order from the older one.

When the operation type is “save”, it means to hold the surrounding information to be the target until the retention period that is designated in the retention period field. That is, it means that the surrounding information whose retention period has passed may be deleted.

The information processor 15 of the information transmission device 10 upon receiving the data operation request specifies the surrounding information to be the target from the surrounding information storage 16 according to the data ID/time range field included in the data operation request. A save flag is set for the specified surrounding information. When the operation type is “save” herein, “1” is set as the save flag, and “0” is set for the case of “not save”. Note, however, that the relationship regarding “0” and “1” may be inverted. Furthermore, a retention period is set for the surrounding information for which the save flag “1” (“save”) is set. No retention period is necessary for the surrounding information for which the save flag “0” (“not save”) is set. The information processor 15 may transmit an acknowledgement (ACK) response for the data operation request.

FIG. 12 is a chart illustrating an example where columns of the save flag and the retention period are added to a table of the surrounding information storage 16. The save flag “1” and the retention period are set for the surrounding information of the first row. The save flag “0” is set for the surrounding information of the second row, and no retention period is set.

The information processor 15 monitors the surrounding information storage 16, and deletes the surrounding information whose retention time has passed or sets the save flag of the surrounding information whose retention time has passed as “0” Furthermore, when the data capacity of the surrounding information storage 16 exceeds a specific value, the information processor 15 preferentially deletes the surrounding information whose save flag is “0” in order from the older one. For example, it may be overwritten by newly acquired surrounding information. When storing the newly acquired surrounding information in the surrounding information storage 16, the save flag is set as “0” as the initial value.

As described above, according to the third modification example, the information collection device 20 designates “save” as the operation type so that it is possible to more securely collect the surrounding information to be uploaded (for example, surrounding information of low similarity S) and reflect it upon the environment model. For example, when the state of the communication line between the base station and the mobile entity M is poor, the mobile entity M may not be able to immediately upload the surrounding information. Even in such a case, it is possible to save the surrounding information and transmit it when the state of the line is improved.

### Fourth Modification Example

In the first embodiment, the first modification example, the second modification example, or the third modification example, the determiner 25 may filter the metadata in the metadata storage 24, and performs the mobile entity selection processing targeted on the filtered metadata. As an example, the determiner 25 includes a rule-based filterer, and performs filtering of the metadata by using the filterer.

For example, conditions regarding the region, place, and the like to be the target for collecting the surrounding information are set in the filterer. The filterer extracts the metadata satisfying the conditions from the metadata storage 24. For example, only the metadata whose positional information belongs to Tokyo is extracted. As another example, only the metadata whose positional information belongs to expressways is extracted. In those cases, the region of Tokyo and the region of expressways are designated in advance in the filterer by coordinates, and the filterer extracts only the metadata having the positional information belonging to the coordinate range. Such designation for the filterer is performed by the administrator of the information collection device through operating the information collection device from the operation terminal. The determiner 25 performs the mobile entity selection processing by using the metadata extracted by the filterer.

As another method, information regarding the prefecture where the mobile entity is in or information whether the mobile entity is on an expressway is added to the metadata transmitted from the mobile entity. In that case, the filterer may perform filtering of the metadata based on the added information included in the metadata.

### Second Embodiment

In this embodiment, an anomaly level regarding the surrounding of the mobile entity M is calculated based on the surrounding information detected by the surrounding sensor 14, and the calculated anomaly level is included in the metadata that is transmitted to the information collection device 20. The information collection device 20 performs the mobile entity selection processing by using at least the anomaly level included in the metadata. For example, the mobile entity that has transmitted the metadata having a high anomaly level is preferentially selected. Hereinafter, the embodiment will be described in detail.

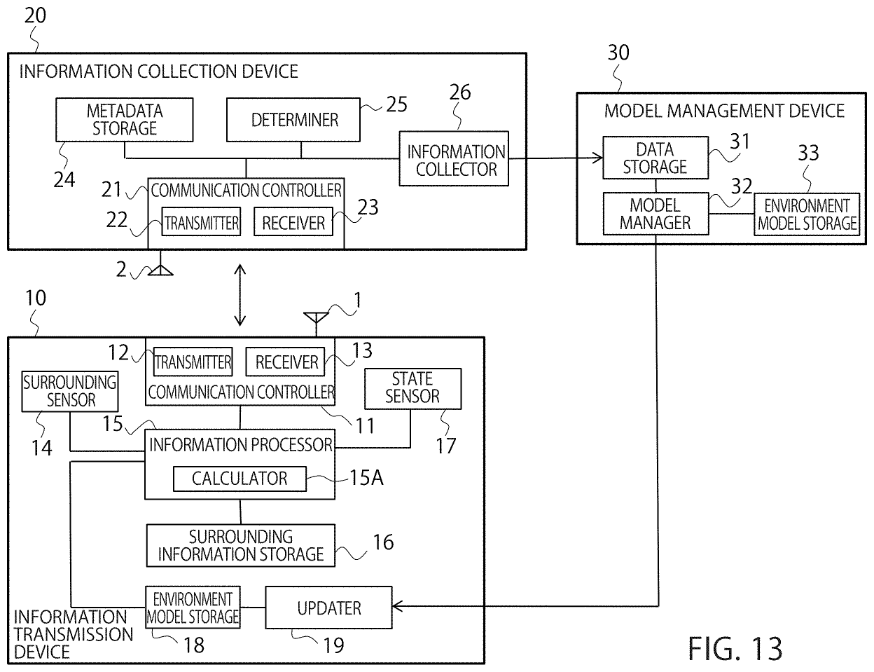

FIG. 13 is a block diagram illustrating an overall configuration of the information transmission device 10 of the mobile entity M, the information collection device 20, and the model management device 30 of the information collection system according to the second embodiment. Even though only the information transmission device 10 of a single mobile entity M is illustrated herein, the information transmission devices 10 of other mobile entities have the same configuration.

Hereinafter, the difference with respect to the first embodiment will mainly be described.

A calculator 15A is added to the information processor 15 of the information transmission device 10 in the mobile entity M. Furthermore, the information processor 15 is connected to the environment model storage 18.

The calculator 15A of the information processor 15 calculates the anomaly level regarding the surrounding of the mobile entity M based on the surrounding information detected by the surrounding sensor 14. As an example, the anomaly level is calculated based on a difference between the detected surrounding information and the environment model expressing the travel environment of the mobile entity.

The anomaly level is the information indicating how the surrounding of the mobile entity M is different from the ordinary. As an example, the anomaly level indicates how the environment is different from the ordinary state (for example, the state indicated by the environment model). As an example, the anomaly level is a numerical value selected from a range defined by a lower limit value and an upper limit value. The anomaly level may be expressed by continuous values or discrete values. As for the anomaly level calculation method, any methods may be used as long as the difference with respect to the environment model can be evaluated therewith. Machine learning or rule base may be used. The anomaly level may include the information indicating the priority level of the detected surrounding information. The calculator 15A determines the priority level based on the anomaly level. The priority level may be defined as higher for the higher anomaly level. The anomaly level may also be considered as the priority level.

As an example for calculating the anomaly level without using prior knowledge, the anomaly level may be calculated based on the fact such as “there is a hole, dent, bump, or a rock fallen on a road”, or the like. Those can be detected as anomalies using a rule base, for example. A configuration for calculating the anomaly level using the environment model and a configuration for calculating the anomaly level without using the environment model are both possible. The value of the anomaly level can be calculated in accordance with the distance to the fallen rock or the like, the size of the fallen rock, and the like, for example. As a specific example, the value of the anomaly level may be defined larger as the distance to the fallen rock, the hole, or the like is closer, or the value of the anomaly level may be defined larger as the size of the fallen rock, the size of the hole, or the like is larger. Furthermore, the value of the anomaly level may be calculated in accordance with the type of the detected anomaly. For example, the value of the anomaly level may be set as “90” in a case of fallen rock, and the value of the anomaly level may be set as “40” in a case of dent.

As examples of a case calculating the anomaly level by using the prior knowledge, there may be a case where the driving lane indicated in the image of the surrounding information is different from the driving lane of the environment model (map) (for example, the width is different). Furthermore, there may be a case where the line (white line or the like) of the driving lane may be faded or the like. Furthermore, a traffic cone may be disposed in a drivable area on the map. Moreover, construction work may be carried out in a drivable area on the map. Furthermore, there may be placed a signboard or a traffic sign that are not on the map. Moreover, there may be a crowded place. As an example, such anomalies are detected by generating in advance a model by machine learning for detecting a traffic cone or a sign indicating that it is in construction work or the like. At this time, information of segmented images of the surrounding information may be used. The values of the anomaly level can also be calculated by reflecting those upon the model as teaching signals in advance by machine learning.

There may be a single (one dimensional) or a plurality of (multidimensional) anomaly levels calculated by the calculator 15A of the information processor 15.

The anomaly level calculation algorithm in the calculator 15A of the information processor 15 is preferable to be common to a plurality of mobile entities M. Furthermore, the environment models stored in the plurality of mobile entities M are also preferable to be common to the plurality of mobile entities M.

The information processor 15 generates the metadata including the node ID, the data ID, the anomaly level calculated by the calculator 15A, the state information of the mobile entity M, the time information, and the like. The information processor 15 transmits the metadata to the information collection device 20 via the transmitter 12. The information processor 15 may control transmission of the metadata by using a threshold value regarding the anomaly level. For example, the information processor 15 may transmit the metadata only when the anomaly level is equal to or more than the threshold value.

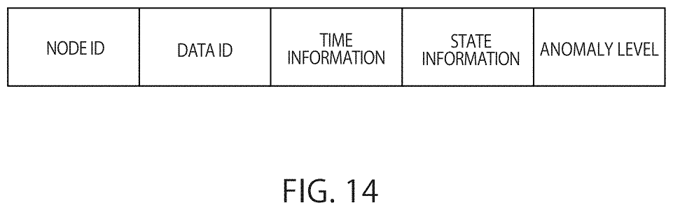

FIG. 14 illustrates a format example of the metadata according to the second embodiment. An anomaly level field is added to the format of FIG. 4A of the first embodiment. In the anomaly level field, the value of anomaly level calculated by the calculator 15A is set. When transmitting a plurality of kinds of anomaly levels, a plurality of sets each having the type of anomaly (for example, anomaly type ID) and the value of anomaly level are set. When a plurality of kinds of anomaly levels are calculated, it is also possible to calculate a statistic such as the average value, the maximum value, or the minimum value thereof, and transmit the statistic as the representative anomaly level. While the anomaly level field is added to the format of FIG. 4A herein, the anomaly level field may also be added to the format of FIG. 4B or to other formats. A part of the fields may be eliminated from the formats of FIG. 14, or another filed may be added thereto.

The determiner 25 of the information collection device 20 receives the metadata from the information transmission device 10 of the mobile entity M via the receiver 23, and provides the received metadata to the metadata storage 24. The metadata storage 24 stores the provided metadata in the storage area inside thereof.

The determiner 25 performs the mobile entity selection processing for selecting the mobile entity caused to upload the surrounding information based on the metadata stored in the metadata storage 24. Hereinafter, two examples of the mobile entity selection processing will be discussed as a first example and a second example. In the first example, the mobile entity is selected by using the anomaly level without using the state information. In the second example, the mobile entity is selected by using both of the anomaly level and the state information.

### First Example

The determiner 25 sorts the metadata in the metadata storage 24 in the descending order of anomaly level. The metadata having a higher anomaly level is preferentially selected, and the mobile entity that has transmitted the selected metadata is selected as the mobile entity caused to upload the surrounding information. The number and the like of the mobile entities to be selected may be determined as in the first embodiment. The processing thereafter is the same as that of the first embodiment or each of the modification examples.

### Second Example

The determiner 25 sorts the metadata in the metadata storage 24 in the descending order of anomaly level. The metadata having the highest anomaly level is selected first. The selected metadata is defined as MA[1]. Note that “MA[i]” means the metadata selected in the i-th order.

The distance between the state information of the selected metadata MA[1] and the state information of each piece of other metadata (defined as MB) is calculated. The similarity (E) is calculated by taking the reciprocal of the distance or the reciprocal of the value acquired by adding a predetermined value (for example, “1”) to the distance. A calculation formula of the distance is expressed as follows, for example.

d=β(nₓ−mₓ)²+γ(n_{y}−m_{y})² (3)

Note that “d” is the distance, “nₓ” and “n_{y}” are the positional information (x coordinate and y coordinate) of the metadata MB, “mₓ” and “m_{y}” are the positional information (x coordinate and y coordinate) of the metadata MA, and “β” and “γ” are positive weight coefficients given in advance.

The formula (3) is an example of the calculation formula of the distance, and various modifications are possible. For example, a term of the difference regarding the time information may be added. Furthermore, a term of the difference regarding the orientations may be added. It is also possible to add a term of a difference regarding information other than those mentioned herein. Furthermore, while the case of the two-dimensional positional information is discussed in the formula (3), the positional information may also be three-dimensional.

The determiner 25 subtracts a larger value as the similarity is lower (as the distance is larger) from the anomaly level of the metadata MB. For example, a discount rate corresponding to the similarity is calculated, and a value acquired by multiplying the anomaly level by the discount rate is subtracted from the anomaly level. Thereby, the anomaly level is updated.

The discount rate “r” is calculated by a following formula, for example. Note that “α” is an arbitrary positive coefficient, and “E” is the similarity.

r=1/{(α*E²)+1} (4)

Furthermore, an example of an anomaly level update formula using the discount rate is presented below. Note that “a” is the anomaly level, and “a′” is the updated anomaly level.

a′=a−a*r (5)

Thereby, update is performed such that the value of the anomaly level of the other metadata MB becomes smaller as the position, orientation, and the like thereof is closer to those of the selected metadata MA[1].

The pieces of updated metadata MB are sorted in the descending order of anomaly level.

The metadata having the highest anomaly level is selected from the sorted pieces of metadata MB. The selected metadata is defined as “MA[2]”. The other pieces of metadata (excluding the metadata MA[i] selected heretofore) are defined as MB.

Hereinafter, the same processing as the processing described above is repeated until a specific number of pieces of metadata (for the number of mobile entities to be selected) are selected or until all pieces of metadata are sorted out. Thereby, h-pieces (“h” is an integer of 1 or larger) of metadata MA[1], MA[2], . . . , MA[h] are selected.

The determiner 25 determines the mobile entities that have transmitted the pieces of metadata MA[1], MA[2], . . . , MA[h] selected by the mobile entity selection processing as the mobile entities caused to upload the surrounding information. The determiner 25 deletes the pieces of metadata MA[1], MA[2], . . . , MA[h] from the metadata storage 24. Alternatively, a “selected” flag may be set to indicate that those are to be excluded from the selection target in the processing thereinafter.

Now, an example of the processing performed when adding new metadata received from the mobile entity M to the sorted pieces of metadata will be discussed.

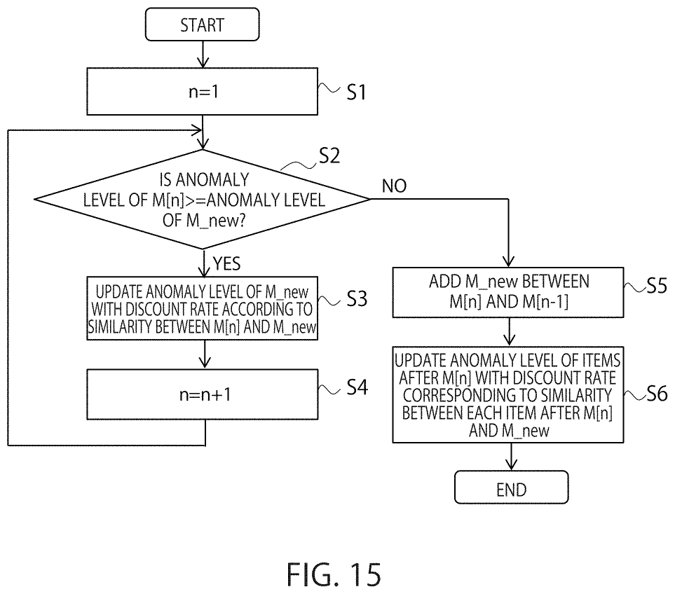

FIG. 15 is a flowchart illustrating an example of the processing for adding the metadata. The n-th metadata that has been sorted is expressed as “M[n]”. The metadata added anew is defined as “M_new”.

In step S1, it is defined as “n=1”.

In step S2, it is determined whether the anomaly level of M[n] is equal to or more than the anomaly level of M_new. When the anomaly level of M[n] is equal to or more than the anomaly level of M_new, the processing is shifted to step S3. When the anomaly level of M[n] is less than the anomaly level of M_new, the processing is shifted to step S4.

When the anomaly level of M[n] is equal to or more than the anomaly level of M_new, the similarity between M_new and M[n] is calculated in step S3. Then, the anomaly level of M_new is updated by the discount rate corresponding to the similarity. Then, “n” is incremented by 1 (S4), and the processing is returned to step S2.

When the anomaly level of M[n] is less than the anomaly level of M_new (NO in S2), M_new is added between M[n] and M[n−1].

In step S6, the anomaly levels of the items after M[n] are updated with the discount rates corresponding to the similarities between each of the items after M[n] and M_new.

As described above, according to the embodiment, it is possible to perform collection of the surrounding information by achieving high use efficiency of the communication capacity through selecting the mobile entities caused to upload the surrounding information based on the anomaly levels. Furthermore, since the total data communication traffic transmitted from each of the mobile entities can be suppressed, an occurrence of communication congestion can be prevented.

### First Modification Example

When the metadata includes a plurality of kinds of anomaly levels, that is, the anomaly levels are multidimensional, the determiner 25 performs the mobile entity selection processing by using a single anomaly level selected therefrom. For example, the largest anomaly level or the smallest anomaly level is used. Alternatively, the average value or the total weighting of the anomaly levels may be used. As described, the mobile entities can be selected by comprehensively evaluating the plurality of kinds of anomaly levels.

### Second Modification Example

For calculating the similarity, the state information, the time information, and the like are used in the formula (3) and the like. However, values of other than the state information may be used as long as those are the items included in the metadata. For example, a term expressing a difference regarding the user events, a difference regarding types of the sensors, specifications, or the like may be added to the similarity calculation formula (for example, the formula (3)).

### Third Modification Example

The anomaly level may be calculated on the information collection device 20 side. Furthermore, the priority level may be determined on the information collection device 20 side based on the anomaly level. For example, the priority level may be determined to be higher for the higher anomaly level. The anomaly level may be considered as the priority level. The determiner 25 of the information collection device 20 calculates the anomaly level by using the information included in the metadata received from the mobile entity M. For example, the anomaly level is calculated based on the user event. As an example, a table is held in which the user events and the anomaly levels are associated. The anomaly level corresponding to the value of the event included in the metadata is specified from the table. The specified anomaly level is used for the mobile entity selection processing. As long as the anomaly level is calculated by using the information included in the metadata, the anomaly level calculation method is not limited thereto.

### Third Embodiment

While the case where the transmission control request is the upload request is mainly discussed in the first and second embodiments, other modes will be described in more detail in this embodiment.

### First Example

The transmission control request may be a request (transmission rate change request) for changing the transmission rate of the surrounding information. For example, when metadata having a higher anomaly level (priority level) than that of a mobile entity B is received from a mobile entity A, the information collection device 20 transmits a transmission rate change request indicating the mobile entity A to increase the transmission rate of the surrounding information, and transmits a transmission rate change request indicating the mobile entity B to lower the transmission rate of the surrounding information. This makes it possible to have the mobile entity A and the mobile entity B change the transmission rate of the surrounding information in the middle of transmission. As described in the third modification example of the second embodiment, the anomaly level and the priority level may also be determined on the information collection device 20 side.

To lower the transmission rate may mean to set the transmission rate as “0”, that is, may mean to stop transmission. For example, when the mobile entity A starts to transmit the metadata regarding a high priority level while the mobile entity B is transmitting the surrounding information regarding a low priority level, transmission from the mobile entity B may be stopped by designating “0” for the transmission rate thereof. Alternatively, when the mobile entity A starts to transmit the metadata regarding a high priority level while the mobile entity A is transmitting the surrounding information regarding a low priority level, transmission of the surrounding information regarding a low priority level from the mobile entity A may be stopped.

As another example, the transmission rate change request may be transmitted to the mobile entity A, when it is desired to decimate the surrounding information transmitted from the mobile entity A. For example, when the mobile entity is not moving due to the traffic jam, it is possible to request the mobile entity A to lower the transmission rate. In that case, the mobile entity A may operate to change the sampling rate of the surrounding information (decimate the surrounding information to be acquired) according to the transmission rate.

The information collection device 20 can control the image quality of applications (mapping application, autonomous driver assistance application, and the like), for example, by controlling the transmission rate. For example, when collecting the surrounding information in order to generate a high-quality map, surrounding information with a high image quality (large data size) may be transmitted at a low rate. Meanwhile, when it requires urgency (requires high real-time property) in a case of remote monitoring such as autonomous driver assistance, surrounding information with a low image quality (small data size) may be transmitted at a high rate.

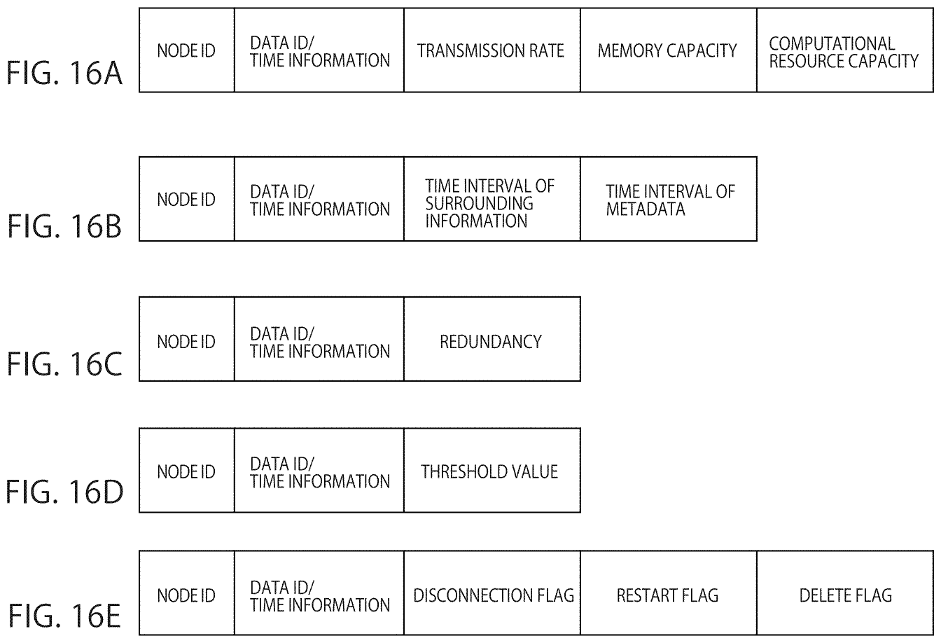

FIG. 16A is a chart illustrating a format example of the transmission control request (transmission rate change request) according to the first example of the third embodiment. The transmission control request includes fields of a node ID, a data ID/time information, a transmission rate, a memory capacity, and a computational resource capacity.

The node ID is the ID of the mobile entity as the target. The data ID/time information is the information for specifying the surrounding information to be the target, and it is the data ID, a set of the data ID and the time information (timestamp), or a set of the data ID and the time range. The transmission rate designates the value of the transmission rate. The transmission rate is the data amount that can be transmitted per unit time in the communication network, for example. The memory capacity indicates the memory data amount that can be received in the information collection device 20. The computational resource processing capacity is the processing capacity that can be processed in the information collection device 20 (for example, the number of frames that can be processed per unit time (fps: frames per second)).

There may not be all of the fields of the transmission rate, the memory capacity, and the computational resource capacity, but there may be at least one of those. When expecting the mobile entity to do continuous transmission, for example, the information collection device 20 may designate the transmission rate. When expecting the mobile entity to do transmission not to exceed the memory capacity, the memory capacity is designated. Furthermore, when expecting that the load of the information collection device 20 does not become overloaded, the computational resource capacity may be designated.

The mobile entity adjusts the transmission rate based on at least one of the transmission rate, the memory capacity, and the computational resource capacity. For example, the mobile entity grasps the data amount that can be transmitted based on the memory capacity, and the mobile entity determines the transmission rate of the surrounding information based on the data amount. As an example, corresponding relations between the transmission rates and the data amounts are held, and the transmission rate is determined based on the corresponding relations.

### Second Example

The transmission control request may be a request (transmission interval change request) for changing the acquisition time interval of the surrounding information or the acquisition time interval of the metadata. For example, the transmission interval change request may be a request for changing the acquisition rate of the image the mobile entity acquires from the surrounding sensor 14. For example, the frame rate (fps) of the image is changed from 0.5 to 0.1. For example, in a case of a road on a country side (a road with the same scenery continuously going on) where high resolution is not necessary, the network bandwidth and the computational resources of the mobile entity can be saved by decimating the surrounding information. Similarly, in a case of a road on a country side (a road with the same scenery continuously going on) where high resolution is not necessary, the network bandwidth and the computational resources of the mobile entity can be saved by decimating the metadata transmitted from the mobile entity.

FIG. 16B is a chart illustrating a format example of the transmission control request (transmission interval change request) according to the second example. The transmission control request includes fields of a node ID, a data ID/time information, a surrounding information time interval, and a metadata time interval. The node ID and the data ID/time information are the same as those of FIG. 16A. The surrounding information time interval field designates the acquisition time interval of the surrounding information. The metadata time interval field designates the acquisition time interval of the metadata. At least only one of the surrounding information time interval field and the metadata time interval field may be included as well.

### Third Example

The transmission control request may be a request (redundancy change request) for changing the redundancy of the surrounding information. For example, the determiner 25 of the information collection device 20 determines the redundancy based on at least one of the metadata and the anomaly level (priority level), and transmits the redundancy change request including the determined redundancy to the mobile entity. The mobile entity transmits the surrounding information with the redundancy designated in the redundancy change request. As examples for changing the redundancy, there may be cases where the number of times the same surrounding information is transmitted may be changed, where whether or not to have error correction coding may be switched, where the error correction coding rate of the surrounding information is changed, where the error correction coding method is switched, and the like. For example, when increasing the redundancy, the same surrounding information is transmitted for a plurality of times. In a case of data whose real-time property is important, it may become necessary to increase the redundancy of the surrounding information. For example, in a case where the metadata indicates that the real-time property is important and the anomaly level is equal to or more than a threshold value, the redundancy is set as a predetermined value higher than ordinary. Note that the anomaly level calculation method for the mobile entity may be stored in the mobile entity (information transmission device) in advance or may be notified to each mobile entity from the information collection device 20. The notification timing thereof may be when the connection to each of the mobile entities is established or at an arbitrary timing after connection is established, or the anomaly level calculation method may be included in ACK transmitted in arbitrary communication. By transmitting the notification from the information collection device 20, update can be easily done even when the anomaly level calculation method is changed.

FIG. 16C is a chart illustrating a format example of the transmission control request (redundancy change request) according to the third example. The transmission control request includes fields of a node ID, a data ID/time information, and a redundancy. The node ID and the data ID/time information are the same as those of FIG. 16A. In the redundancy field, the redundancy determined based on at least one of the metadata and the anomaly level (priority level) is stored.

### Fourth Example

The transmission control request may be a request (metadata control request) for requesting transmission of the metadata satisfying a designated condition. For example, the metadata control request designates not to transmit the metadata when the anomaly level is less than the threshold value or “0”. That is, the metadata control request requests transmission of only the metadata having the anomaly level equal to or more than the threshold value. This makes it possible to save the network bandwidth and the computational resources of the mobile entity. The condition for transmitting the metadata may be stored in the mobile entity (information transmission device) in advance or may be notified to each mobile entity from the information collection device 20. The notification timing thereof may be when the connection to each of the mobile entities is established or at an arbitrary timing after connection is established, or the condition may be included in ACK transmitted in arbitrary communication. By transmitting the notification from the information collection device 20, update can be easily done even when the condition for transmitting the metadata is changed.

FIG. 16D is a chart illustrating a format example of the transmission control request (metadata control request) according to the fourth example. The transmission control request includes fields of a node ID, a data ID/time information, and a threshold value. The node ID and the data ID/time information are the same as those of FIG. 16A. In the threshold value field, the threshold value is stored.

### Fifth Example

The transmission control request may be a request (transmission stop request) for requesting to stop transmission of the surrounding information. Transmission of the surrounding information may be stopped explicitly or may be stopped by disconnecting the mobile entity. A transmission control request may be defined for restarting transmission again after stopping it once. A designation for deleting the surrounding information stored in the mobile entity may be included explicitly in the transmission control request. If there is no chance of restarting the transmission of the surrounding information stored in the mobile entity after the transmission is stopped, the surrounding information may be deleted to increase the resource capacity. Note that designation of the surrounding information to be the target may be performed by the data ID, a set of the data ID and the time information (timestamp), or a set of the data ID and the time range as in the case of the first embodiment.

FIG. 16E is a chart illustrating a format example of the transmission control request (transmission stop request) according to the fifth example. The transmission stop request includes fields of a node ID, a data ID/time information, a disconnection flag, a restart flag, and a delete flag. The node ID and the data ID/time information are the same as those of FIG. 16A. The node ID and the data ID/time information are the same as those of FIG. 16A. The disconnection flag designates disconnection. The restart flag designates restart of transmission of the surrounding information. The delete flag designates deletion of the surrounding information. There may be only one of the fields of the disconnection flag, the restart flag, and the delete flag.

### Others

The transmission control request may be defined by combining the various examples described above. In that case, a combination of the information described in the various examples may be stored in the transmission control request packet.

### Hardware Configuration

In the information collection system according to each of the embodiments and each of the modification examples described above, each function may be an analog circuit, a digital circuit, or an analog/digital mixed circuit. A control circuit for controlling each of the functions may be provided as well. Each of the circuits may be implemented by ASIC (Application Specific Integrated circuit), FPGA (Field Programmable Gate Array), or the like. As an example, the transmitter 12 may be configured by a transmission circuit, the receiver 13 may be configured by a reception circuit, and the other structural components (for example, at least any one of or an arbitrary combination of the information processor 15, structural components other than the transmitter 12 and the receiver 13 in the communication controller 11, the updater 19, and the like) may be configured by a processing circuit.

In the whole description above, at least a part of the information collection system may be configured with hardware, or may be configured with software to cause a CPU, a GPU, or the like to work therefor by the information processing of the software. In a case configured with software, a program implementing the information collection system and at least a part of the functions thereof may be stored in a storage medium such as a flexible disk, a CD-ROM, or the like to be loaded on a computer and executed therein. The storage medium is not limited to a removable one such as a magnetic disk or an optical disk but may also be a fixed storage medium such as a hard disk drive or a memory. That is, the information processing executed by the software may be implemented specifically by using hardware resources. Furthermore, the processing executed by the software may be implemented on the circuit such as FPGA to be executed by the hardware.

For example, by causing a computer to read out dedicated software stored in a computer readable storage medium, the computer can work as the devices of the embodiments described above. The types of the storage medium are not specifically limited. Furthermore, by installing the dedicated software downloaded via a communication network to the computer, the computer can work as the devices of the embodiments described above. In the manner described above, the information processing by the software can be specifically implemented by using the hardware resources.

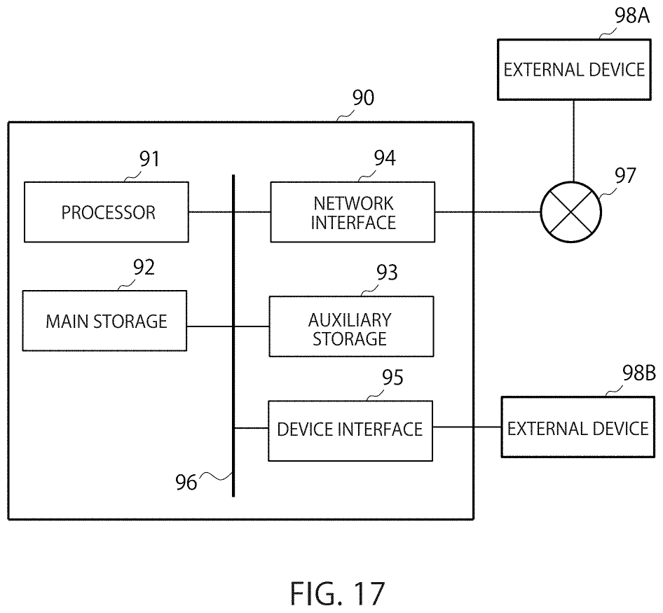

FIG. 17 is a block diagram illustrating an example of a hardware configuration according to an embodiment of the present disclosure. The information transmission device 10 or the information collection device 20 in the information collection system can be implemented as a computer device 90 that includes a processor 91, a main storage 92, an auxiliary storage 93, a network interface 94, and a device interface 95 connected via a bus 96.

While the computer device 90 in FIG. 17 includes one each of the structural components, there may also be a plurality of same structural components provided therein. Furthermore, while a single computer device 90 is illustrated in FIG. 17, software may be installed on a plurality of computer devices and each of the plurality of computer devices may execute a different part of the software.

The processor 91 is an electronic circuit (processing circuit, processing circuitry) including a control device and an arithmetic device of the computer. The processor 91 performs arithmetic processing according to data and a program input from each device and the like of the inside configuration of the computer device 90, and outputs the calculated result thereof and a control signal to each device and the like. Specifically, the processor 91 controls each of the structural components configuring the computer device 90 by executing the OS (operating system) of the computer device 90, applications, and the like. There is no specific limit set for the processor 91 as long as the processing described above can be performed therewith. Each of the structural components is achieved by the processor 91. There may be a single or a plurality of processors 91.

The main storage 92 is a storage that stores instructions, various kinds of data, and the like executed by the processor 91, and information stored in the main storage 92 is directly read out by the processor 91. The auxiliary storage 93 is a storage other than the main storage 92. Those storages may be arbitrary electronic components that can store electronic information, which may be memories or storages. Furthermore, the memory may be a volatile memory or nonvolatile memory. Various kinds of storages belonging within the information transmission device 10 or the information collection device 20 may be achieved by the main storage 92 or the auxiliary storage 93.

The network interface 94 is an interface for connecting to a communication network 97 wirelessly or with wire. For the network interface 94, those that conform to the existing communication standards may be used. Information may be exchanged with an external device 98A by the network interface 94 via the communication network 97. The communication network 97 corresponds to at least one of the communication network 40, the communication network 50, and the wireless LAN.

Assuming that the computer device 90 is the information transmission device 10, the external device 98A is the information collection device 20, the model management device 30, or the like. Assuming that the computer device 90 is the information collection device 20, the external device 98A is the information transmission device 10, the model management device 30, or the like. Furthermore, the external device 98A may be a device that has at least a part of the functions of the structural components of the information collection system. Furthermore, the computer device 90 may receive a part of the processing result of the information collection system via the communication network 97 like a cloud service.

The device interface 95 is an interface of a serial bus standard or the like directly connected to an external device 98B. The external device 98B is a sensor (surrounding sensor, state sensor, another sensor, or the like), an output device, an external storage medium, a storage, or the like. The output device may be a display device for displaying images or a device for outputting sound and the like, for example. While not limited thereto, examples thereof may be an LCD (Liquid Crystal Display), a CRT (Cathode Ray Tube), a PDP (Plasma Display Panel), and a speaker.

Note that the external device 98B may be an input device. The input device includes devices such as a keyboard, a mouse, a touch panel, and the like, and gives the information input via those devices to the computer device 90. Signals from the input device are output to the processor 91. Furthermore, a part of or a whole part of the processing, means, and the like of the present disclosure may be executed or caused to function based on at least one of the control circuit or the memory circuit provided on the cloud via the network.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. An information transmission device comprising:
processing circuitry configured to acquire surrounding information of a mobile entity including the information transmission device;
transmitting circuitry configured to transmit first data including state information of the mobile entity, the first data not including the surrounding information, a data size of the state information is smaller than a data size of the surrounding information; and
receiving circuitry configured to receive a transmission control request of the surrounding information after the first data is transmitted, the transmission control request being generated based on the first data, wherein
the transmitting circuitry is configured to control transmission of the surrounding information based on the transmission control request.

2. The device according to claim 1, wherein the transmitting circuitry is configured to transmit the first data before transmitting the surrounding information.

3. The device according to claim 1, wherein the transmitting circuitry is configured to transmit the surrounding information in response to receiving the transmission control request.

4. The device according to claim 1, wherein the transmitting circuitry is configured to control at least one of a transmission rate, a redundancy, or a transmission interval of the surrounding information based on the transmission control request.

5. The device according to claim 1, wherein the transmitting circuitry is configured to specify surrounding information to be transmitted based on identification information of the surrounding information included in the transmission control request.

6. The device according to claim 1, wherein the processing circuitry is configured to calculate an anomaly level of surrounding of the mobile entity based on the surrounding information, wherein
the first data includes the anomaly level.

7. The device according to claim 5, wherein the processing circuitry is configured to calculate the anomaly level based on an environment model included in the mobile entity.

8. The device according to claim 1, wherein the state information includes at least one of positional information, orientation information, speed information, or acceleration information of the mobile entity.

9. The device according to claim 1, wherein the surrounding information is information detected by at least one of a camera or a LiDAR included in the mobile entity.

10. The device according to claim 1, wherein the surrounding information is information detected by at least one of a sensor that detects a steering angle of the mobile entity, a sensor that detects depression of at least one of an accelerator pedal or a brake pedal of the mobile entity, a sensor that detects a fuel injection amount in engine control of the mobile entity, or a sensor that detects at least one of engine speed, speed, or gear ratio of the mobile entity.

11. The device according to claim 1, wherein the surrounding information is at least one of image data or point cloud data.

12. The device according to claim 1, wherein the state information includes information on a user event occurring in the mobile entity when the surrounding information is acquired.

13. An information collection device comprising:
receiving circuitry configured to receive a plurality of pieces of first data including state information of first mobile entities;
processing circuitry configured to determine a second mobile entity for a transmission control among the first mobile entities based on the plurality of pieces of the first data; and
transmitting circuitry configured to transmit a transmission control request of surrounding information to the second mobile entity.

14. The device according to claim 13, wherein
the receiving circuitry is configured to receive surrounding information transmitted in accordance with the transmission control request, and
the processing circuitry is configured to provide the surrounding information of the second mobile entity to a model management device, the model management device being configured to manage environment models for the first mobile entities.

15. The device according to claim 13, wherein:
the processing circuitry is configured to schedule an acquisition order of the surrounding information of a plurality of the second mobile entities based on the plurality of pieces of the first data; and
the transmitting circuitry is configured to transmit the transmission control request to the plurality of second mobile entities according to the acquisition order.

16. The device according to claim 13, wherein:
the plurality of pieces of the first data include anomaly levels in surrounding of the first mobile entities; and
the processing circuitry is configured to determine the second mobile entity based on the anomaly levels.

17. The device according to claim 16, wherein:
the processing circuitry is configured to schedule an acquisition order of the surrounding information of a plurality of the second mobile entities based on the anomaly levels of the second mobile entities; and
the transmitting circuitry is configured to transmit the transmission control request to the second mobile entities according to the acquisition order.

18. The device according to claim 13, wherein the transmitting circuitry is configured to transmit information designating a retention period for retaining the surrounding information of the second mobile entity.

19. An information transmission method comprising:
acquiring surrounding information of a mobile entity;
transmitting first data including state information of the mobile entity, the first data not including the surrounding information, a data size of the state information is smaller than a data size of the surrounding information; and
receiving a transmission control request of the surrounding information after the first data is transmitted, the transmission control request being generated based on the first data; and
controlling transmission of the surrounding information based on the transmission control request.

20. An information collection method comprising:
receiving a plurality of pieces of first data including state information of first mobile entities;
determining a second mobile entity for a transmission control among the first mobile entities based on the plurality of pieces of the first data; and
transmitting a transmission control request of surrounding information to the second mobile entity.
